(19) United States
(12) Patent Application Publication
(10) Pub. No.: US 2024/0365409 A1
(43) Pub. Date: Oct. 31, 2024

(54) METHOD OF gNB-CU-CP APPARATUS, METHOD OF AMF APPARATUS AND gNB-CU-CP APPARATUS

(71) Applicant: NEC CORPORATION, Minato-ku, Tokyo (JP)

(72) Inventors: Toshiyuki TAMURA, Tokyo (JP); Iskren IANEV, Tokyo (JP); Kundan TIWARI, Tokyo (JP)

(73) Assignee: NEC CORPORATION, Minato-ku, Tokyo (JP)

(21) Appl. No.: 18/684,267

(22) PCT Filed: Jul. 27, 2022
(86) PCT No.: PCT/JP2022/028882

§ 371 Date: Feb. 16, 2024

(30) Foreign Application Priority Data
Aug. 28, 2021 (IN) 202111039053

(51) Int. Cl. H04W 76/12; H04W 72/1268

(52) U.S. Cl. CPC H04W 76/12; H04W 72/1268

(57) ABSTRACT

This disclosure proposes solutions for providing an optimized User plane handling in 5GS.

A method of a communication apparatus includes executing a function of a gNB Centralized Unit User Plane (gNB-CU-UP) apparatus and function of a User Plain Function (UPF) apparatus, communicating with a gNB Distributed Unit (gNB-DU) apparatus, and communicating with a gNB Centralized Unit-Control Plane (gNB-CU-CP) apparatus.

### TECHNICAL FIELD

This present disclosure relates to a method of a communication apparatus, a method of a gNB-CU-CP apparatus, a method of an AMF apparatus, a method of an SMF apparatus, a method of a gNB-DU apparatus, a method of a UPF apparatus, a communication apparatus, a gNB-CU-CP apparatus, an AMF apparatus, an SMF apparatus, a gNB-DU apparatus and a UPF apparatus.

### BACKGROUND ART

The overall architecture for NG-RAN is shown in NPL 2. The NG-RAN includes a set of gNBs connected to the 5GC through the NG interface. A gNB may include a gNB-CU and one or more gNB-DU(s).

### CITATION LIST

### Non Patent Literature

[NPL 1] 3GPP TR 21.905: “Vocabulary for 3GPP Specifications”. V17.0.0 (2020-07)
[NPL 2] 3GPP TS 38.401: “NG-RAN; Architecture description”. V16.6.0 (2021-07)
[NPL 3] RWS-210327: “Motivation of Study on Inter-gNB Coordination” https://www.3gpp.org/ftp/tsg_ran/TSG_RAN/TSGR_AHs/2021_06_RA N_Rel18_WS/Docs/RWS-210327.zip
[NPL 4] 3GPP TS 38.472: “NG-RAN; F1 signalling transport”. V16.1.0 (2020-09)
[NPL 5] IETF RFC 4960 (2007-09): “Stream Control Transmission Protocol”
[NPL 6] 3GPP TS 38.473: “NG-RAN; F1 application protocol (F1AP)”. V16.6.0 (2021-07)
[NPL 7] 3GPP TS 38.462: “NG-RAN; E1 signalling transport”. V16.1.0 (2020-09)
[NPL 8] 3GPP TS 38.463: “NG-RAN; F1 application protocol (F1AP)”. V16.6.0 (2021-07)
[NPL 9] 3GPP TS 38.412: “NG-RAN; NG signalling transport”. V16.1.0 (2020-09)
[NPL 10] 3GPP TS 38.413: “NG Application Protocol (NGAP)”. V16.6.0 (2021-07)
[NPL 11] 3GPP TS 38.422: “NG-RAN; Xn signalling transport”. V16.0.0 (2020-03)
[NPL 12] 3GPP TS 38.423: “Xn Application Protocol (XnAP)”. V16.6.0 (2021-07)
[NPL 13] 3GPP TS 23.501: “System architecture for the 5G System (5GS)”. V17.1.1 (2021-06)
[NPL 14] 3GPP TS 23.502: “Procedures for the 5G System (5GS)”. V17.1.0 (2021-06)
[NPL 15] 3GPP TS 38.474: “F1 data transport”. V16.1.0 (2021-01)
[NPL 16] 3GPP TS 29.281: “General Packet Radio System (GPRS) Tunnelling Protocol User Plane (GTPv1-U)”. V17.1.0 (2021-06)

### SUMMARY OF INVENTION

### Technical Problem

There are at least three user plane entities, i.e. gNB-DU, gNB-CU-UP and UPF in 5GS, to handle the user data according to NPL 13 and NPL 2. It is a fact that whenever user data traverses the user plane entities, it adds a transmission delay. On the other hand high performance in user data handling with respect to latency is required if the 5GS is used for time critical application such as for example, remote machine control, drone control, or remote surgery.

In order to meet low latency requirements, the current 5GS architecture may be too redundant to fulfill the identified requirements.

### Solution to Problem

In an aspect of the present disclosure, a method of a communication apparatus, the method includes executing a function of a gNB Centralized Unit User Plane (gNB-CU-UP) apparatus and function of a User Plain Function (UPF) apparatus, communicating with a gNB Distributed Unit (gNB-DU) apparatus, and communicating with a gNB Centralized Unit-Control Plane (gNB-CU-CP) apparatus.

In an aspect of the present disclosure, a method of a gNB Centralized Unit Control Plane (gNB-CU-CP) apparatus includes receiving a Protocol Data Unit (PDU) session establishment request message from a User Equipment (UE). The method includes sending an UPLINK NAS TRANSPORT message to an Access and Mobility management Function (AMF) apparatus. The UPLINK NAS TRANSPORT message includes the PDU session establishment request message and information indicating that the gNB-CU-CP apparatus supports communication with a communication apparatus which executes a function of a gNB Centralized Unit User Plane (gNB-CU-UP) apparatus and function of a User Plain Function (UPF) apparatus. The method includes receiving an INITIAL CONTEXT SETUP REQUEST message from the AMF apparatus. The INITIAL CONTEXT SETUP REQUEST message includes information related to the gNB-CU-UP. The method includes selecting the gNB-CU-UP based on the information related to the gNB-CU-UP. The method includes performing PDU session establishment procedure for the UE.

In an aspect of the present disclosure, a method of an Access and Mobility management Function (AMF) apparatus includes receiving an UPLINK NAS TRANSPORT message from a gNB Centralized Unit Control Plane (gNB-CU-CP) apparatus. The UPLINK NAS TRANSPORT message includes a Protocol Data Unit (PDU) session establishment request message and information indicating that the gNB-CU-CP apparatus supports communication with a communication apparatus which executes function of a gNB Centralized Unit User Plane (gNB-CU-UP) apparatus and function of a User Plain Function (UPF) apparatus. The method includes sending a Nsmf_PDUSession_CreateSMContext Request message to a Session Management Function (SMF) apparatus. The Nsmf_PDUSession_CreateSMContext Request message includes the information. The method includes receiving a Nsmf_PDUSession_CreateSMContext response message from the SMF apparatus. The Nsmf_PDUSession_CreateSMContext response message includes information related to the UPF apparatus. The method includes receiving a Namf_Communication_N1N2MessageTransfer message from the SMF apparatus. The Namf_Communication_N1N2MessageTransfer message includes information related to the gNB-CU-UP apparatus. The method includes sending an INITIAL CONTEXT SETUP REQUEST message to the gNB-CU-CP apparatus. The INITIAL CONTEXT SETUP REQUEST message includes the information related to the gNB-CU-UP apparatus. The method includes performing PDU session establishment procedure.

In an aspect of the present disclosure, a method of a Session Management Function (SMF) apparatus includes receiving a Nsmf_PDUSession_CreateSMContext Request message from an Access and Mobility management Function (AMF) apparatus. The Nsmf_PDUSession_CreateSMContext Request message includes information indicating that a gNB Centralized Unit Control Plane (gNB-CU-CP) apparatus supports communication with a communication apparatus which executes function of a gNB Centralized Unit User Plane (gNB-CU-UP) apparatus and function of a User Plain Function (UPF) apparatus. The method includes sending a Nsmf_PDUSession_CreateSMContext response message to the AMF apparatus. The Nsmf_PDUSession_CreateSMContext response message includes information related to the UPF apparatus. The method includes selecting the UPF apparatus in a case where the Nsmf_PDUSession_CreateSMContext Request message includes the information. The method includes contacting to the communication apparatus for reserving a resource for handling of user data. The method includes sending a Namf_Communication_N1N2MessageTransfer message to the AMF apparatus. The Namf_Communication_N1N2MessageTransfer message includes information related to the gNB-CU-UP apparatus. The method includes performing PDU session establishment procedure.

In an aspect of the present disclosure, a method of a gNB Distributed Unit (gNB-DU) apparatus includes communicating with a gNB Centralized Unit Control Plane (gNB-CU-CP) apparatus, and communicating with a User Plane Function (UPF) apparatus without a gNB Centralized Unit User Plane (gNB-CU-UP) apparatus.

In an aspect of the present disclosure, a method of a gNB Centralized Unit Control Plane (gNB-CU-CP) apparatus includes communicating with a gNB Distributed Unit (gNB-DU) apparatus, and communicating with a User Plane Function (UPF) apparatus without a gNB Centralized Unit User Plane (gNB-CU-UP) apparatus.

In an aspect of the present disclosure, a method of an Access and Mobility management Function (AMF) apparatus includes receiving an UPLINK NAS TRANSPORT message from a gNB Centralized Unit Control Plane (gNB-CU-CP) apparatus. The UPLINK NAS TRANSPORT message includes first information indicating that the gNB-CU-CP apparatus supports that a gNB Distributed Unit (gNB-DU) apparatus is connected to a User Plane Function (UPF) apparatus without a gNB Centralized Unit User Plane (gNB-CU-UP) apparatus. The method includes sending a Nsmf_PDUSession_CreateSMContext Request message to a Session Management Function (SMF) apparatus. The Nsmf_PDUSession_CreateSMContext Request message includes the first information. The method includes receiving a Nsmf_PDUSession_CreateSMContext response message from the SMF apparatus. The Nsmf_PDUSession_CreateSMContext response message includes second information indicating that the UPF apparatus supports that the gNB-DU apparatus is connected to the UPF apparatus without the gNB-CU-UP apparatus. The method includes receiving a Namf_Communication_N1N2MessageTransfer message from the SMF apparatus. The Namf_Communication_N1N2MessageTransfer message includes gNB-CU-UP UE E1AP ID and third information indicating a pair of an Internet Protocol (IP) address and a Tunnel Endpoint Identifier (TEID) for uplink data handling. The method includes sending an INITIAL CONTEXT SETUP REQUEST message to the gNB-CU-CP apparatus. The INITIAL CONTEXT SETUP REQUEST message includes the gNB-CU-UP UE E1AP ID and the third information. The method includes receiving an INITIAL CONTEXT SETUP RESPONSE message from the gNB-CU-CP apparatus. The method includes performing PDU session establishment procedure.

In an aspect of the present disclosure, a method of a Session Management Function (SMF) apparatus includes receiving a Nsmf_PDUSession_CreateSMContext Request message from an Access and Mobility management Function (AMF) apparatus. The Nsmf_PDUSession_CreateSMContext Request message includes first information indicating that a gNB Centralized Unit Control Plane (gNB-CU-CP) apparatus supports that a gNB Distributed Unit (gNB-DU) apparatus is connected to a User Plane Function (UPF) apparatus without a gNB Centralized Unit User Plane (gNB-CU-UP) apparatus. The method includes sending a Nsmf_PDUSession_CreateSMContext response message to the AMF apparatus. The Nsmf_PDUSession_CreateSMContext response message includes second information indicating that the UPF apparatus supports that the gNB-DU apparatus is connected to the UPF apparatus without the gNB-CU-UP apparatus. The method includes sending a N4 Session Establishment Request message to the UPF apparatus. The N4 Session Establishment Request message includes the first information. The method includes receiving a N4 Session Establishment Response message from the UPF apparatus. The N4 Session Establishment Response message includes gNB-CU-UP UE E1AP ID and third information indicating a pair of an Internet Protocol (IP) address and a Tunnel Endpoint Identifier (TEID) for uplink data handling. The method includes sending a Namf_Communication_N1N2MessageTransfer message to the AMF apparatus. The Namf_Communication_N1N2MessageTransfer message includes the gNB-CU-UP UE E1AP ID and the third information. The method includes performing PDU session establishment procedure.

In an aspect of the present disclosure, a method of a User Plane Function (UPF) apparatus includes communicating with a gNB Distributed Unit (gNB-DU) apparatus without a gNB Centralized Unit User Plane (gNB-CU-UP) apparatus, and communicating with a gNB Centralized Unit Control Plane (gNB-CU-CP) apparatus without the gNB-CU-UP apparatus.

In an aspect of the present disclosure, a communication apparatus includes means for executing a function of a gNB Centralized Unit User Plane (gNB-CU-UP) apparatus and function of a User Plain Function (UPF) apparatus, means for communicating with a gNB Distributed Unit (gNB-DU) apparatus, and means for communicating with a gNB Centralized Unit Control Plane (gNB-CU-CP) apparatus.

In an aspect of the present disclosure, a gNB Centralized Unit Control Plane (gNB-CU-CP) apparatus includes means for receiving a Protocol Data Unit (PDU) session establishment request message from a User Equipment (UE). The gNB-CU-CP apparatus includes means for sending an UPLINK NAS TRANSPORT message to an Access and Mobility management Function (AMF) apparatus. The UPLINK NAS TRANSPORT message includes the PDU session establishment request message and information indicating that the gNB-CU-CP apparatus supports communication with a communication apparatus which executes a function of a gNB Centralized Unit User Plane (gNB-CU-UP) apparatus and function of a User Plain Function (UPF) apparatus. The gNB-CU-CP apparatus includes means for receiving an INITIAL CONTEXT SETUP REQUEST message from the AMF apparatus. The INITIAL CONTEXT SETUP REQUEST message includes information related to the gNB-CU-UP. The gNB-CU-CP apparatus includes means for selecting the gNB-CU-UP based on the information related to the gNB-CU-UP. The gNB-CU-CP apparatus includes means for performing PDU session establishment procedure for the UE.

In an aspect of the present disclosure, an Access and Mobility management Function (AMF) apparatus includes means for receiving an UPLINK NAS TRANSPORT message from a gNB Centralized Unit Control Plane (gNB-CU-CP) apparatus. The UPLINK NAS TRANSPORT message includes a Protocol Data Unit (PDU) session establishment request message and information indicating that the gNB-CU-CP apparatus supports communication with a communication apparatus which executes function of a gNB Centralized Unit User Plane (gNB-CU-UP) apparatus and function of a User Plain Function (UPF) apparatus. The AMF apparatus includes means for sending a Nsmf_PDUSession_CreateSMContext Request message to a Session Management Function (SMF) apparatus. The Nsmf_PDUSession_CreateSMContext Request message includes the information. The AMF apparatus includes means for receiving a Nsmf_PDUSession_CreateSMContext response message from the SMF apparatus. The Nsmf_PDUSession_CreateSMContext response message includes information related to the UPF apparatus. The AMF apparatus includes means for receiving a Namf_Communication_N1N2MessageTransfer message from the SMF apparatus. The Namf_Communication_N1N2MessageTransfer message includes information related to the gNB-CU-UP apparatus. The AMF apparatus includes means for sending an INITIAL CONTEXT SETUP REQUEST message to the gNB-CU-CP apparatus. The INITIAL CONTEXT SETUP REQUEST message includes the information related to the gNB-CU-UP apparatus. The AMF apparatus includes means for performing PDU session establishment procedure.

In an aspect of the present disclosure, a Session Management Function (SMF) apparatus includes means for receiving a Nsmf_PDUSession_CreateSMContext Request message from an Access and Mobility management Function (AMF) apparatus. The Nsmf_PDUSession_CreateSMContext Request message includes information indicating that a gNB Centralized Unit Control Plane (gNB-CU-CP) apparatus supports communication with a communication apparatus which executes function of a gNB Centralized Unit User Plane (gNB-CU-UP) apparatus and function of a User Plain Function (UPF) apparatus. The SMF apparatus includes means for sending a Nsmf_PDUSession_CreateSMContext response message to the AMF apparatus. The Nsmf_PDUSession_CreateSMContext response message includes information related to the UPF apparatus. The SMF apparatus includes means for selecting the UPF apparatus in a case where the Nsmf_PDUSession_CreateSMContext Request message includes the information. The SMF apparatus includes means for contacting to the communication apparatus for reserving a resource for handling of user data. The SMF apparatus includes means for sending a Namf_Communication_N1N2MessageTransfer message to the AMF apparatus. The Namf_Communication_N1N2MessageTransfer message includes information related to the gNB-CU-UP apparatus. The SMF apparatus includes means for performing PDU session establishment procedure.

In an aspect of the present disclosure, a gNB Distributed Unit (gNB-DU) apparatus includes means for communicating with a gNB Centralized Unit Control Plane (gNB-CU-CP) apparatus, and means for communicating with a User Plane Function (UPF) apparatus without a gNB Centralized Unit User Plane (gNB-CU-UP) apparatus.

In an aspect of the present disclosure, a gNB Centralized Unit Control Plane (gNB-CU-CP) apparatus includes means for communicating with a gNB Distributed Unit (gNB-DU) apparatus, and means for communicating with a User Plane Function (UPF) apparatus without a gNB Centralized Unit User Plane (gNB-CU-UP) apparatus.

In an aspect of the present disclosure, an Access and Mobility management Function (AMF) apparatus includes means for receiving an UPLINK NAS TRANSPORT message from a gNB Centralized Unit Control Plane (gNB-CU-CP) apparatus. The UPLINK NAS TRANSPORT message includes first information indicating that the gNB-CU-CP apparatus supports that a gNB Distributed Unit (gNB-DU) apparatus is connected to a User Plane Function (UPF) apparatus without a gNB Centralized Unit User Plane (gNB-CU-UP) apparatus.

The AMF apparatus includes means for sending a Nsmf_PDUSession_CreateSMContext Request message to a Session Management Function (SMF) apparatus. The Nsmf_PDUSession_CreateSMContext Request message includes the first information. The AMF apparatus includes means for receiving a Nsmf_PDUSession_CreateSMContext response message from the SMF apparatus. The Nsmf_PDUSession_CreateSMContext response message includes second information indicating that the UPF apparatus supports that the gNB-DU apparatus is connected to the UPF apparatus without the gNB-CU-UP apparatus. The AMF apparatus includes means for receiving a Namf_Communication_N1N2MessageTransfer message from the SMF apparatus. The Namf_Communication_N1N2MessageTransfer message includes gNB-CU-UP UE E1AP ID and third information indicating a pair of an Internet Protocol (IP) address and a Tunnel Endpoint Identifier (TEID) for uplink data handling. The AMF apparatus includes means for sending an INITIAL CONTEXT SETUP REQUEST message to the gNB-CU-CP apparatus. The INITIAL CONTEXT SETUP REQUEST message includes the gNB-CU-UP UE E1AP ID and the third information. The AMF apparatus includes means for receiving an INITIAL CONTEXT SETUP RESPONSE message from the gNB-CU-CP apparatus. The AMF apparatus includes means for performing PDU session establishment procedure.

In an aspect of the present disclosure, a Session Management Function (SMF) apparatus includes means for receiving a Nsmf_PDUSession_CreateSMContext Request message from an Access and Mobility management Function (AMF) apparatus. The Nsmf_PDUSession_CreateSMContext Request message includes first information indicating that a gNB Centralized Unit Control Plane (gNB-CU-CP) apparatus supports that a gNB Distributed Unit (gNB-DU) apparatus is connected to a User Plane Function (UPF) apparatus without a gNB Centralized Unit User Plane (gNB-CU-UP) apparatus. The SMF apparatus includes means for sending a Nsmf_PDUSession_CreateSMContext response message to the AMF apparatus. The Nsmf_PDUSession_CreateSMContext response message includes second information indicating that the UPF apparatus supports that the gNB-DU apparatus is connected to the UPF apparatus without the gNB-CU-UP apparatus. The SMF apparatus includes means for sending a N4 Session Establishment Request message to the UPF apparatus. The N4 Session Establishment Request message includes the first information. The SMF apparatus includes means for receiving a N4 Session Establishment Response message from the UPF apparatus. The N4 Session Establishment Response message includes gNB-CU-UP UE E1AP ID and third information indicating a pair of an Internet Protocol (IP) address and a Tunnel Endpoint Identifier (TEID) for uplink data handling. The SMF apparatus includes means for sending a Namf_Communication_N1N2MessageTransfer message to the AMF apparatus. The Namf_Communication_N1N2MessageTransfer message includes the gNB-CU-UP UE E1AP ID and the third information. The SMF apparatus includes means for performing PDU session establishment procedure.

In an aspect of the present disclosure, A User Plane Function (UPF) apparatus includes means for communicating with a gNB Distributed Unit (gNB-DU) apparatus without a gNB Centralized Unit User Plane (gNB-CU-UP) apparatus, and means for communicating with a gNB Centralized Unit Control Plane (gNB-CU-CP) apparatus without the gNB-CU-UP apparatus.

### BRIEF DESCRIPTION OF DRAWINGS

FIG. 1 illustrates an NG-(R)AN architecture.

FIG. 2 illustrates an NG-(R)AN architecture with Collocated gNB-CU-UP and UPF.

FIG. 3 illustrates a PDU session establishment procedure for Collocated gNB-CU-UP and UPF.

FIG. 4 illustrates an NG-(R)AN architecture without gNB-CU-UP.

FIG. 5 illustrates a PDU session establishment procedure without gNB-CU-UP.

FIG. 6 illustrates System overview.

FIG. 7 is a block diagram for User equipment (UE).

FIG. 8 is a block diagram for (R)AN node.

FIG. 9 illustrates a System overview of (R)AN node based on O-RAN architecture.

FIG. 10 is a block diagram for Radio Unit (RU).

FIG. 11 is a block diagram for Distributed Unit (DU).

FIG. 12 is a block diagram for Centralized Unit (CU).

FIG. 13 is a block diagram for Access and Mobility Management Function (AMF).

FIG. 14 is a block diagram for Session Management Function (SMF).

FIG. 15 is a block diagram for User Plane Function (UPF).

FIG. 16 is a block diagram for Policy Control Function (PCF).

FIG. 17 is a block diagram for Network Exposure Function (NEF).

FIG. 18 is a block diagram for Unified Data Management (UDM).

FIG. 19 is a block diagram for Network Data Analytics Function (NWDAF).

### DESCRIPTION OF EMBODIMENTS

The disclosure relates to a method of a communication apparatus, a method of a gNB-CU-CP apparatus, a method of an AMF apparatus, a method of an SMF apparatus, a method of a gNB-DU apparatus, a method of a UPF apparatus, a communication apparatus, a gNB-CU-CP apparatus, an AMF apparatus, an SMF apparatus, a gNB-DU apparatus and a UPF apparatus.

In the following detailed description, for purposes of explanation, numerous specific details are set forth in order to provide a thorough understanding of the disclosed aspects. It will be apparent, however, that one or more aspects may be practiced without these specific details. In other instances, well-known structures and devices are schematically shown in order to simplify the drawing.

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in the each Aspects described below may be implemented independently or in combination with any other. These Aspects include novel characteristics different from one another. Accordingly, these Aspects contribute to achieving objects or solving problems different from one another and contribute to obtaining advantages different from one another.

### Abbreviations

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
ABBA Anti-Bidding-down Between Architectures
AF Application Function
AMF Access and Mobility Management Function
AN Access Network
API Application Programming Interface
AS Access Stratum
ATSSS Access Traffic Steering, Switching, Splitting
ATSSS-LL ATSSS Low-Layer
AUSF Authentication Server Function
AUTN Authentication token
BBF Broadband Forum
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
CU Centralized Unit/Central Unit
DAPS Dual Active Protocol Stacks
DL Downlink
DN Data Network
DNAI DN Access Identifier
DNN Data Network Name
DRB Data Radio Bearer
DRX Discontinuous Reception
DS-TT Device-side TSN translator
DU Distributed Unit
ePDG evolved Packet Data Gateway
EAP Extensible Authentication Protocol
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
gNB-CU-CP gNB Central Unit Control Plane
gNB-CU-UP gNB Central Unit User Plane
gNB-DU gNB Distributed Unit
GPSI Generic Public Subscription Identifier
GUAMI Globally Unique AMF Identifier
GUTI Globally Unique Temporary UE Identity
HR Home Routed (roaming)
IAB Integrated access and backhaul
IMEI International Mobile Equipment Identity
IMEI/TAC IMEI Type Allocation Code
IMS IP Multimedia Subsystem
IOWN Innovative Optical and Wireless Network
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
LTE Long Term Evolution
MAC Medium Access Control
MCC Mobile country code
MCX Mission Critical Service
MDBV Maximum Data Burst Volume
MFBR Maximum Flow Bit Rate
MICO Mobile Initiated Connection Only
MNC Mobile Network Code
MO Mobile Originated
MPS Multimedia Priority Service
MPTCP Multi-Path TCP Protocol
MT Mobile Terminated
MT Mobile Termination
N3IWF Non-3GPP InterWorking Function
N5CW Non-5G-Capable over WLAN
NAI Network Access Identifier
NAS Non-Access Stratum
NEF Network Exposure Function
NF Network Function
NFV Network Functions Virtualization
NGAP Next Generation Application Protocol
ngKSI Next Generation Key Set Identifier
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NW-TT Network-side TSN translator
NWDAF Network Data Analytics Function
O&M Operations & Maintenance
O-RAN Open RAN Alliance
O-DU O-RAN Distributed Unit
O-CU O-RAN Centralized Unit
O-RU O-RAN Radio Unit
PCF Policy Control Function
PDB Packet Delay Budget
PDCP Packet Data Convergence Protocol
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
QoS Quality of Service
RACS Radio Capabilities Signalling optimisation
(R)AN (Radio) Access Network
RG Residential Gateway
RU Radio Unit
RIM Remote Interference Management
RLC Radio Link Control
RQA Reflective QoS Attribute
RQI Reflective QoS Indication
RRC Radio Resource Control
RSN Redundancy Sequence Number
SA NR Standalone New Radio
SBA Service Based Architecture
SBI Service Based Interface
SCP Service Communication Proxy
SD Slice Differentiator
SDAP Service Data Adaptation Protocol
SEAF Security Anchor Functionality
SEPP Security Edge Protection Proxy
SMF Session Management Function
SMS Short Message Service
SMSF Short Message Service Function
SN Sequence Number
SN name Serving Network Name.
SNPN Stand-alone Non-Public Network
S-NSSAI Single Network Slice Selection Assistance Information
SOR Steering Of Roaming
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TAI Tracking Area Identity
TCP Transmission Control Protocol
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UP User Plane
UPF User Plane Function
URLLC Ultra Reliable Low Latency Communication
URRP-AMF UE Reachability Request Parameter for AMF
URSP UE Route Selection Policy
UU Interface between User Equipment and Radio Access Network
VID VLAN Identifier
VLAN Virtual Local Area Network
W-5GAN Wireline 5G Access Network
W-5GBAN Wireline BBF Access Network
W-5GCAN Wireline 5G Cable Access Network
W-AGF Wireline Access Gateway Function
WLAN Wireless Local Area Network
WUS Wake Up Signal

### Definitions

For the purposes of the present document, the terms and definitions given in NPL 1 and the following apply. A term defined in the present document takes precedence over the definition of the same term, if any, in NPL 1.

### General

This disclosure proposes solutions for providing an optimized User plane handling in 5GS. For example, this disclosure proposes solutions for improving the latency on user data handling in 5GS.

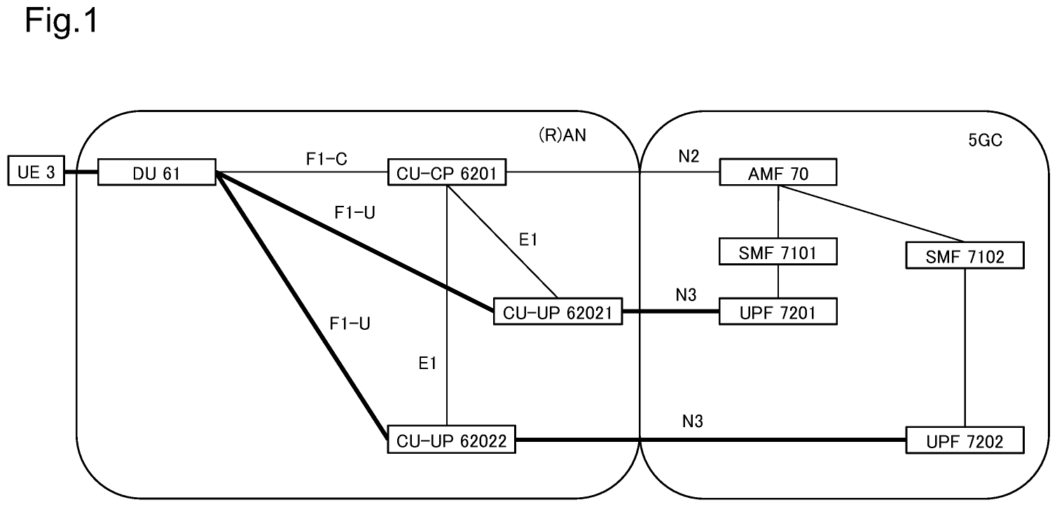

The FIG. 1 illustrates the NG-(R)AN architecture as defined by a combination of NPL 13 and NPL 2.

This is the target architecture that this disclosure proposes to be evolved from.

Note that the following interpretations can apply in this disclosure.
gNB-CU-CP can be interpreted as gNB-CU-Control Plane.
CU-CP can be interpreted as gNB-CU-Control Plane.
gNB-CU-UP can be interpreted as gNB-CU-User Plane.
CU-UP can be interpreted as gNB-CU-User Plane.
DU can be interpreted as gNB-DU.
F1 interface can be interpreted as F1 reference point.

Although this disclosure mainly discloses solutions to gNB, all aspects in this disclosure are equally applicable to the ng-eNB. In order to apply the solutions to ng-eNB, the following replacements are needed.
gNB-CU-CP and CU-CP are replaced with ng-eNB-CU-CP.
gNB-CU-UP and CU-UP are replaced with ng-eNB-CU-UP.
gNB-DU and DU are replaced with ng-eNB-DU.
F1 interface and F1 reference point are replaced with W1 interface and W1 reference point respectively.
   <First Aspect: NG-(R)AN Architecture with Collocated gNB-CU-UP and UPF>

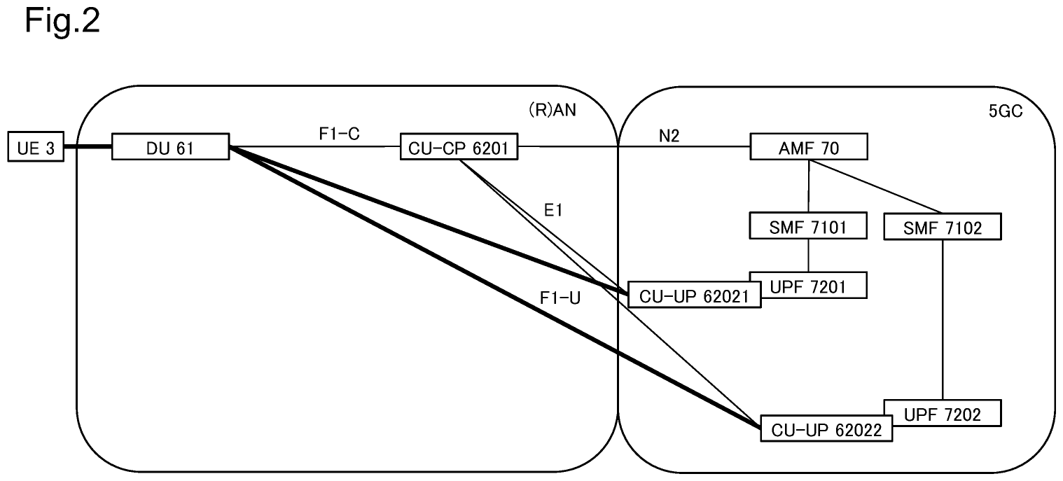

The FIG. 2 illustrates a proposed NG-(R)AN architecture with Collocated (or Co-located) gNB-CU-UP and UPF. The Collocated gNB-CU-UP and UPF implies that gNB-CU-UP and UPF share the same physical server, the same hardware module or the same virtual module. For example, a blade server for gNB-CU-UP and another blade server for UPF are mounted to the same Chassis. For example, function of gNB-CU-UP and function of UPF may be implemented by a same memory and at least one same hardware processor coupled to the memory in a communication apparatus.

With this approach, gNB-CU-UP failure due to hardware failure, virtual resource failure and related facility failure can be reduced as the total number of involved hardware for the PDU session end to end can be lower.

In addition, a service quality in transport layer in 5GS can be improved by this architecture as it can diminish the N3 connection.

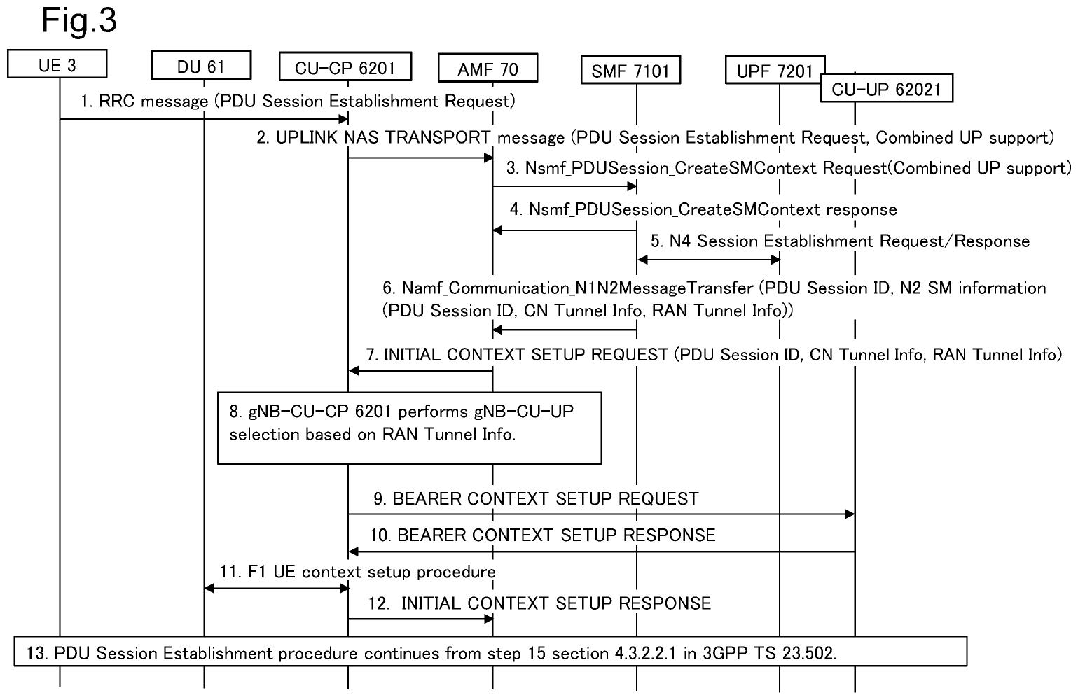

The detailed processes for establishing PDU session with collocated gNB-CU-UP and UPF are illustrated in FIG. 3.

The detailed processes of the procedure are described as below.

1. The UE sends RRC message including a NAS message “PDU session establishment request” to the gNB-CU-CP 6201 via the gNB-DU 61.

2. The gNB-CU-CP 6201 sends, to the AMF 70, UPLINK NAS TRANSPORT message including NAS message “PDU session establishment request” and Combined UP support parameter. The Combined UP support parameter indicates to the AMF 70 that the gNB-CU-CP 6201 supports a collocated gNB-CU-UP and UPF configuration based on an instruction from the 5GC. The Combined UP support parameter may indicate to the AMF that the gNB-CU-CP 6201 supports a collocated gNB-CU-UP and UPF configuration. The Combined UP support parameter may indicate that the gNB-CU-CP 6201 supports communication with a communication apparatus executing function of a collocated gNB-CU-UP and UPF.

3. Upon reception of UPLINK NAS TRANSPORT message from the gNB-CU-CP 6201, the AMF 70 sends, to the SMF 7101, Nsmf_PDUSession_CreateSMContext Request message including NAS message “PDU session establishment request” and Combined UP support parameter. The NAS message “PDU session establishment request” may be same to the NAS message “PDU session establishment request” included in the UPLINK NAS TRANSPORT message in step 2. The Combined UP support parameter may be same to the Combined UP support parameter in the UPLINK NAS TRANSPORT message in step 2. The Combined UP support parameter may indicate to the SMF 7101 that at least one of the gNB-CU-CP 7101 and the AMF 70 support a collocated gNB-CU-UP and UPF configuration based on an instruction from the 5GC. The Combined UP support parameter may indicate to the SMF 7101 that at least one of the gNB-CU-CP 6201 and the AMF 70 support a collocated gNB-CU-UP and UPF configuration.

4. Upon reception of Nsmf_PDUSession_CreateSMContext Request message from the AMF 70 including NAS message “PDU session establishment request”, the SMF 7101 sends Nsmf_PDUSession_CreateSMContext response message to the AMF 70. The Nsmf_PDUSession_CreateSMContext response message may include Combined UP support parameter. The combined UP support parameter indicates to the AMF 70 that the UPF is capable for combining with gNB-CU-UP. The combined UP support parameter may indicate to the AMF 70 that the UPF is capable for executing function of gNB-CU-UP. The combined UP support parameter may indicate to the AMF 70 that the UPF is capable for executing function of UPF and function of gNB-CU-UP.

For example, the SMF 7101 may obtain information indicating whether the UPF 7201 is capable for combining with gNB-CU-UP from other network nodes (e.g. UPF 7201), and in a case where the SMF 7101 obtains information indicating that the UPF 7201 is capable for combining with gNB-CU-UP, the SMF 7101 may send, to the AMF 70, the Nsmf_PDUSession_CreateSMContext response message including the Combined UP support parameter which indicates that the UPF 7201 is capable for combining with gNB-CU-UP.

For example, the SMF 7101 may store the information indicating that the UPF 7201 is capable for combining with gNB-CU-UP in advance and the SMF 7101 may send, to the AMF 70, the Nsmf_PDUSession_CreateSMContext response message including the Combined UP support parameter which indicates that the UPF 7201 is capable for combining with gNB-CU-UP.

5. If the Combined UP support parameter was indicated in the Nsmf_PDUSession_CreateSMContext Request message, the SMF 7101 selects a UPF 7201 that is capable to be combined with gNB-CU-UP and contacts to the UPF 7201 for reserving necessary resources for a handling of user data in the UPF 7201. For example, the SMF 7101 may select the UPF 7201 as a UPF that is capable to be combined with gNB-CU-UP in a case where the SMF 7101 obtains the information indicating that the UPF 7201 is capable for combining with gNB-CU-UP or the SMF 7101 stores the information indicating that the UPF 7201 is capable for combining with gNB-CU-UP.

For example, the SMF 7101 may send, to the UPF 7201, N4 Session Establishment Request message for reserving necessary resources for a handling of user data in the UPF 7201, and the UPF 7201 may send N4 Session Establishment Response message in response to the N4 Session Establishment Request message. For example, the UPF 7201 sends the N4 Session Establishment Response message after reserving necessary resources for a handling of user data in the UPF 7201.

Note that step 5 may be performed before step 4.

6. The SMF 7101 sends, to the AMF 70, Namf_Communication_N1N2MessageTransfer message including PDU Session ID, and N2 SM information. The N2 SM information includes PDU Session ID, CN Tunnel Info, and RAN Tunnel Info. The RAN Tunnel Info (or RAN Tunnel Information) can be a FQDN or IP (Internet Protocol) address or IP address with a Tunnel Endpoint Identifier (TEID) of the gNB-CU-UP that can be the best couple of chosen UPF 7201 and gNB-CU-UP for the PDU session. The RAN Tunnel Info may be a FQDN or IP address or IP address with a TEID of the gNB-CU-UP which is collocated with chosen UPF 7201 for the PDU session. The RAN Tunnel Info may be a FQDN or IP address or IP address with a TEID of the gNB-CU-UP 62021 which is collocated with chosen UPF 7201 for the PDU session. The RAN Tunnel Info may be a FQDN of the gNB-CU-UP 62021 or IP address of the gNB-CU-UP 62021 or IP address with a TEID of the gNB-CU-UP 62021. The PDU Session ID may be used by AN to associate with the DRB (Data Radio Bearer) between the AN and the UE 3.

For example, the SMF 7101 may obtain the RAN Tunnel Info from other network nodes (e.g. gNB-CU-UP 62021), and in a case where the SMF 7101 obtains the RAN Tunnel Info, the SMF 7101 may send the Namf_Communication_N1N2MessageTransfer message including the RAN Tunnel Info to the AMF 70.

For example, the SMF 7101 may store the RAN Tunnel Info in advance and the SMF 7101 may send, to the AMF 70, the Namf_Communication_N1N2MessageTransfer message including the RAN Tunnel Info.

7. The AMF 70 sends, to the gNB-CU-CP 6201, INITIAL CONTEXT SETUP REQUEST message including PDU Session ID, CN Tunnel Info and RAN Tunnel Info. The PDU Session ID, the CN Tunnel Info and the RAN Tunnel Info may be same to the PDU Session ID, the CN Tunnel Info and the RAN Tunnel Info received in step 6, respectively.

8. Upon reception of INITIAL CONTEXT SETUP REQUEST message including RAN Tunnel Info, the gNB-CU-CP 6201 selects a gNB-CU-UP based on the received RAN Tunnel Info. For example, in a case where the gNB-CU-UP 62021 is indicated by the RAN Tunnel Info (e.g. in a case where the FQDN or the IP address or the IP address with the TEID of the gNB-CU-UP 62021 is indicated by the RAN Tunnel Info), the gNB-CU-CP 6201 may select the gNB-CU-UP 62021.

9. The gNB-CU-CP 6201 sends BEARER CONTEXT SETUP REQUEST message to the gNB-CU-UP 62021. For example, the gNB-CU-CP 6201 may send BEARER CONTEXT SETUP REQUEST message to the gNB-CU-UP 62021 by using the FQDN or the IP address or the IP address with the TEID of the gNB-CU-UP 62021 which is indicated by the RAN Tunnel Info.

10. The gNB-CU-UP 62021 sends BEARER CONTEXT SETUP RESPONSE message to the gNB-CU-CP 6201.

11. Upon reception of BEARER CONTEXT SETUP RESPONSE message from the gNB-CU-UP 62021, the gNB-CU-CP 6201 contacts to the gNB-DU 61 for setting up the F1 UE context. For example, the gNB-CU-CP 6201 may initiate F1 UE context setup procedure for setting up the F1 UE context.

12. The gNB-CU-CP 6201 sends INITIAL UE CONTEXT SETUP RESPONSE message to the AMF 70.

13. The PDU session establishment procedure continues from step 15 section 4.3.2.2.1 in NPL 14.

### <First Variant of the First Aspect: Service Request Procedure>

The Service request procedure for Co-located gNB-CU-UP and UPF can be realized with following changes to the first aspect.
In step 1, the RRC message includes the Service Request message instead of the PDU Session Establishment Request message.
In step 2, the UPLINK NAS TRANSPORT message includes the NAS Service Request message instead of the PDU Session Establishment Request message.
In step 3, the message name is Nsmf_PDUSession_UpdateSMContext Request instead of Nsmf_PDUSession_CreateSMContext Request. For example, the AMF 70 may send Nsmf_PDUSession_UpdateSMContext Request message instead of the Nsmf_PDUSession_CreateSMContext Request message.
In step 4, the message name is Nsmf_PDUSession_UpdateSMContext Response instead of Nsmf_PDUSession_CreateSMContext Response. For example, SMF 7101 may send Nsmf_PDUSession_UpdateSMContext Response message instead of the Nsmf_PDUSession_CreateSMContext Response message.
In step 13, the procedure to be continued is from the step 15 of the UE Triggered Service Request procedure in section 4.2.3.2 in NPL 14.

At least one of the first aspect and the variant of the first aspect propose solutions for providing an optimized User plane handling in 5GS.

For example, at least one of the first aspect and the variant of the first aspect propose solutions for improving the latency on user data handling in 5GS.

For example, according to at least one of the first aspect and the variant of the first aspect, gNB-CU-UP failure due to hardware failure, virtual resource failure and related facility failure can be reduced as the total number of involved hardware for the PDU session end to end can be lower.

For example, according to at least one of the first aspect and the variant of the first aspect, a service quality in transport layer in 5GS can be improved as it can diminish the N3 connection.

For example, at least one of the first aspect and the variant of the first aspect can solve a problem regarding a transmission delay whenever user data traverses the user plane entities.

For example, at least one of the first aspect and the variant of the first aspect can solve a problem that the current 5GS architecture may be too redundant to fulfill the low latency requirement for time critical application.

<Second Aspect: NG-(R)AN Architecture without gNB-CU-UP>

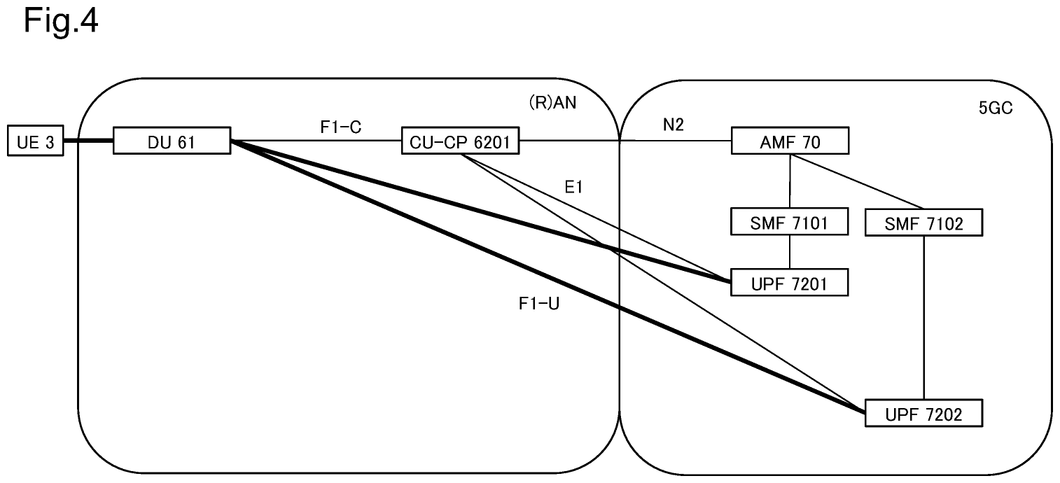

The FIG. 4 illustrates a proposed NG-(R)AN architecture without gNB-CU-UP.

A service quality in transport layer in 5GS can be improved by this architecture as it can diminish the N3 connection.

With this NG-(R)AN architecture, the gNB-DU is directly connected to the UPF. For example, the gNB-DU communicates with the UPF without the gNB-CU-UP. For example, the UPF communicates with the gNB-DU without the gNB-CU-UP.

With this NG-(R)AN architecture, the gNB-CU-CP is directly connected to the UPF. For example, the gNB-CU-CP communicates with the UPF without the gNB-CU-UP. For example, the UPF communicates with the gNB-CU-CP without the gNB-CU-UP.

Note that the reference point between the gNB-DU 61 and the UPF 7201 is indicated as F1-U in the FIG. 4, and the reference point between the gNB-DU 61 and the UPF 7201 can be interpreted as N3 reference point from the UPF 7201's point of view.

Note that the reference point between the gNB-DU 61 and the UPF 7202 is indicated as F1-U in the FIG. 4, and the reference point between the gNB-DU 61 and the UPF 7202 can be interpreted as N3 reference point from the UPF 7202's point of view.

Note that the UPF 7201 can be interpreted as the gNB-CU-UP from the gNB-DU 61's point of view.

Note that the UPF 7201 can be interpreted as the gNB-CU-UP from the gNB-CU-CP 6201's point of view.

Note that the UPF 7202 can be interpreted as the gNB-CU-UP from the gNB-DU 61's point of view.

Note that the UPF 7202 can be interpreted as the gNB-CU-UP from the gNB-CU-CP 6201's point of view.

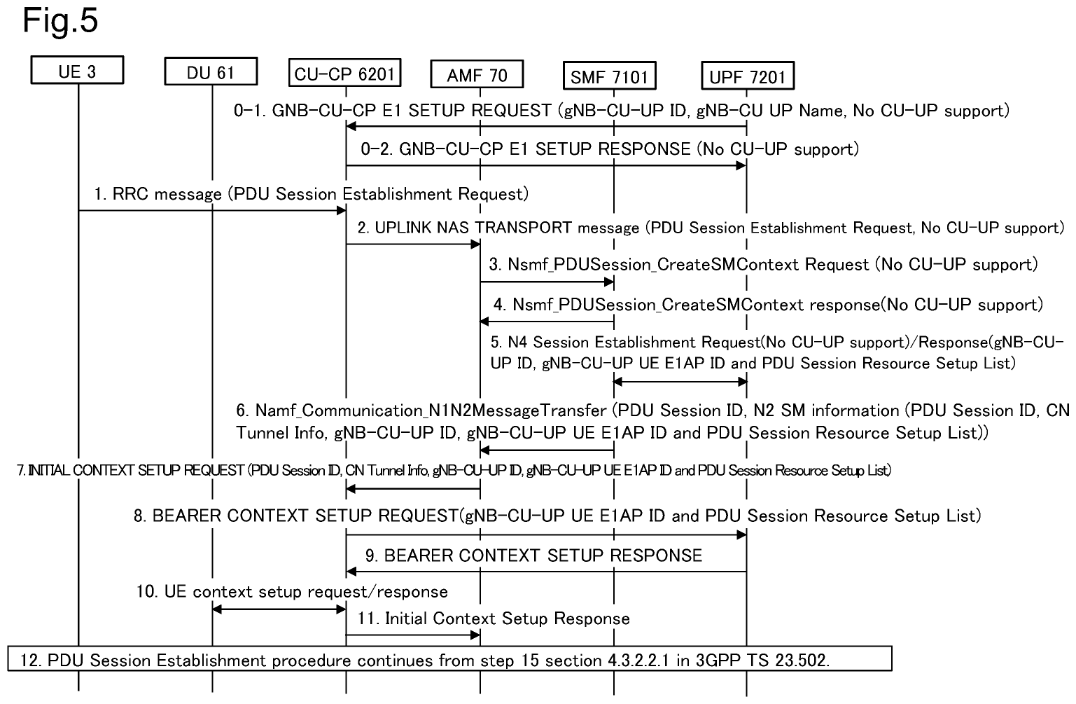

The detailed processes for establishing PDU session without gNB-CU-UP are illustrated in FIG. 5.

The detailed processes of the procedure are described as below.

0-1. The UPF 7201, which is seen as the gNB-CU-UP from the gNB-CU-CP, sends, to the gNB-CU-CP 6201, the GNB-CU-CP E1 SETUP REQUEST message including gNB-CU-UP ID, gNB-CU-UP Name and No CU-UP support parameter. The “No CU-UP support parameter” indicates to the gNB-CU-CP 6201 that UPF 7201 supports “no gNB-CU-UP feature”. The “no gNB-CU-UP feature” implies (or indicates) that the gNB-DU can be directly connected to the UPF without gNB-CU-UP. For example, the no gNB-CU-UP feature may imply that the gNB-DU 61 can be directly connected to the UPF 7201 without gNB-CU-UP. For example, the no gNB-CU-UP feature may imply that the gNB-DU can communicate with the UPF without gNB-CU-UP.

For example, the UPF 7201 may determine whether the UPF 7201 supports the no gNB-CU-UP feature based on a local configuration in the UPF 7201 or stored information in the UPF 7201, and the UPF 7201 may include the No CU-UP support parameter in the GNB-CU-CP E1 SETUP REQUEST message in a case where the UPF 7201 determines that the UPF 7201 supports the no gNB-CU-UP feature.

The no gNB-CU-UP feature may be expressed by DU-UPF direct connection feature, DU-UPF direct bearer feature, Optimized User plane RAN feature or any other notations.

0-2. Upon reception of the GNB-CU-CP E1 SETUP REQUEST message, the gNB-CU-CP 6201 sends, to the UPF 7201, GNB-CU-CP E1 SETUP RESPONSE message including No CU-UP support parameter. The No CU-UP support parameter indicates to the UPF 7201 that gNB-CU-CP 6201 supports the no gNB-CU-UP feature. With the mutual capability negotiation on no gNB-CU-UP feature between UPF 7201 and gNB-CU-CP 6201, this no gNB-CU-UP feature can be activated if both UPF 7201 and gNB-CU-CP support the feature.

For example, the gNB-CU-CP 6201 may determine whether the gNB-CU-CP 6201 supports the no gNB-CU-UP feature based on a local configuration in the gNB-CU-CP 6201 or stored information in the gNB-CU-CP 6201, and the gNB-CU-CP 6201 may include the No CU-UP support parameter in the GNB-CU-CP E1 SETUP RESPONSE message in a case where the gNB-CU-CP 6201 supports the no gNB-CU-UP feature.

1. The UE 3 sends RRC message including a NAS message “PDU session establishment request” to the gNB-CU-CP 6201 via the gNB-DU 61.

2. The gNB-CU-CP 6201 sends, to the AMF 70, UPLINK NAS TRANSPORT message including NAS message “PDU session establishment request” and No CU-UP support parameter. The No CU-UP support parameter indicates to the AMF 70 that the gNB-CU-CP 6201 supports the no gNB-CU-UP feature.

3. Upon reception of UPLINK NAS TRANSPORT message from the gNB-CU-CP 6201, the AMF 70 sends, to the SMF 7101, Nsmf_PDUSession_CreateSMContext Request message including NAS message “PDU session establishment request” and No CU-UP support parameter. The No CU-UP support parameter may indicate to the SMF 7101 that the gNB-CU-CP 6201 supports the no gNB-CU-UP feature.

4. Upon reception of Nsmf_PDUSession_CreateSMContext Request message from the AMF 70 including NAS message “PDU session establishment request”, the SMF 7101 sends Nsmf_PDUSession_CreateSMContext response message to the AMF 70. The Nsmf_PDUSession_CreateSMContext response message may include No CU-UP support parameter. The No CU-UP support parameter indicates to the AMF 70 that the UPF supports the no gNB-CU-UP feature. The No CU-UP support parameter may indicate to the AMF 70 that the UPF 7201 supports the no gNB-CU-UP feature.

For example, the SMF 7101 may obtain information indicating whether the UPF supports the no gNB-CU-UP feature from other network nodes (e.g. UPF 7201), and in a case where the SMF 7101 obtains the information indicating that the UPF 7201 supports the no gNB-CU-UP feature, the SMF 7101 may send, to the AMF 70, the Nsmf_PDUSession_CreateSMContext response message including the No CU-UP support parameter which indicates that the UPF 7201 supports the no gNB-CU-UP feature.

For example, the SMF 7101 may store the information indicating that the UPF 7201 supports the no gNB-CU-UP feature in advance and the SMF 7101 may send, to the AMF 70, the Nsmf_PDUSession_CreateSMContext response message including the No CU-UP support parameter which indicates that the UPF 7201 supports the no gNB-CU-UP feature.

5. If the No CU-UP support parameter is indicated in the Nsmf_PDUSession_CreateSMContext Request message, the SMF 7101 selects a UPF that supports the no gNB-CU-UP feature and sends, to the UPF 7201, the N4 Session Establishment Request message including the No CU-UP support parameter. The No CU-UP support parameter may indicate to the UPF 7201 that the gNB-CU-CP 6201 supports the no gNB-CU-UP feature.

For example, in a case where the No CU-UP support parameter is included in the Nsmf_PDUSession_CreateSMContext Request message (or in a case where the No CU-UP support parameter included in the Nsmf_PDUSession_CreateSMContext Request message indicates that the gNB-CU-CP 6201 supports the no gNB-CU-UP feature and the No CU-UP support parameter included in the Nsmf_PDUSession_CreateSMContext Response message indicates that the UPF 7201 supports the no gNB-CU-UP feature), the SMF 7101 may select the UPF 7201 as the UPF that supports the no gNB-CU-UP feature, and the SMF 7101 sends the N4 Session Establishment Request message including the No CU-UP support parameter indicating that the gNB-CU-CP 6201 supports the no gNB-CU-UP feature.

Upon reception of the N4 Session Establishment Request message including the No CU-UP support parameter, the UPF 7201 reserves the necessary resources for handling of the user data in the UPF 7201 as well as necessary resources for handling of the user data as the gNB-CU-UP.

Once all necessary resources are prepared, the UPF 7201 sends, to the SMF 7101, the N4 Session Establishment Response message including gNB-CU-UP ID, gNB-CU-UP UE E1AP ID and PDU Session Resource Setup List parameter. The PDU Session Resource Setup List parameter includes UL UP Parameters that include an IP address and a TEID pair for UL data handling. The gNB-CU-UP ID indicates an identifier of the UPF 7201 as a gNB-CU-UP. The gNB-CU-UP ID is transferred to the gNB-CU-CP 6201 via the AMF 70 and the gNB-CU-CP 6201 uses this information to find a destination of the BEARER CONTEXT SETUP REQUEST message in step 8. The gNB-CU-UP UE E1AP ID may be allocated so as to uniquely identify the UE over the E1 interface within the UPF 7201.

6. The SMF 7101 sends, to the AMF 70, Namf_Communication_N1N2MessageTransfer message including PDU Session ID and N2 SM information. The N2 SM information includes PDU Session ID, CN Tunnel Info, gNB-CU-UP ID, gNB-CU-UP UE E1AP ID and PDU Session Resource Setup List parameter. The PDU Session ID may be used by AN to associate with the DRB (Data Radio Bearer) between the AN and the UE. The gNB-CU-UP UE E1AP ID and the PDU Session Resource Setup List parameter may be same to the gNB-CU-UP UE E1AP ID and the PDU Session Resource Setup List parameter received in step 5, respectively. The CN Tunnel Info is conveyed to the gNB-CU-CP 6201 via the AMF 70 indicating it as the user plane endpoint in the UPF 7201. The CN Tunnel Info may indicate the user plane endpoint in the UPF 7201. Note that the step 10 describes how CN Tunnel Info is used by the gNB-CU-CP 6201 for establishing a gNB-DU 61 to UPF 7201 direct connection.

7. The AMF 70 sends, to the gNB-CU-CP 6201, INITIAL CONTEXT SETUP REQUEST message including PDU Session ID, CN Tunnel Info, gNB-CU-UP ID and gNB-CU-UP UE E1AP ID and PDU Session Resource Setup List parameter. The gNB-CU-UP UE E1AP ID and the PDU Session Resource Setup List parameter may be same to the gNB-CU-UP UE E1AP ID and the PDU Session Resource Setup List parameter received in step 6, respectively.

8. Upon reception of INITIAL CONTEXT SETUP REQUEST message including gNB-CU-UP ID, gNB-CU-UP UE E1AP ID and PDU Session Resource Setup List parameter, the gNB-CU-CP 6201 finds the UPF 7201, as the gNB-CU-UP from gNB-CU-CP 6201 point of view, based on the received gNB-CU-UP ID in the INITIAL CONTEXT SETUP REQUEST message. The gNB-CU-CP 6201 may confirm whether the No CU-UP support feature is supported by the UPF 7201 by checking the “No CU-UP support parameter” in the GNB-CU-CP E1 SETUP REQUEST message in step 0-1. If No CU-UP support feature is not supported by the UPF 7201, then gNB-CU-CP 6201 finds an appropriate gNB-CU-UP and sends the BEARER CONTEXT SETUP REQUEST message to the found gNB-CU-UP without gNB-CU-UP UE E1AP ID and PDU Session Resource Setup List parameter and continues the PDU session establishment procedure without No CU-UP support feature. Otherwise (that is, if No CU-UP support feature is supported by the UPF 7201), the gNB-CU-CP 6201 sends, to the UPF 7201 as the gNB-CU-UP, BEARER CONTEXT SETUP REQUEST message including gNB-CU-UP UE E1AP ID and PDU Session Resource Setup List parameter. The gNB-CU-UP UE E1AP ID and the PDU Session Resource Setup List parameter should be the same with the gNB-CU-UP UE E1AP ID and the PDU Session Resource Setup List parameter received in step 7, respectively.

9. The UPF 7201 links to the reserved resources in step 5 based on the received gNB-CU-UP UE E1AP ID and sends BEARER CONTEXT SETUP RESPONSE message to the gNB-CU-CP 6201. For example, the UPF 7201 may link the received gNB-CU-UP UE E1AP ID to the reserved resources in step 5.

10. Upon reception of BEARER CONTEXT SETUP RESPONSE message from the UPF 7201, the gNB-CU-CP 6201 contacts to the gNB-DU 61 for setting up the F1 UE context.

For setting up the F1 UE context, the gNB-CU-CP 6201 sends, to the gNB-DU 61, the UE CONTEXT SETUP REQUEST message including the UL Configuration IE in DRB to Be Setup Item IE with the information in the PDU Session Resource Setup List parameter that is received in INITIAL CONTEXT SETUP REQUEST message at step 7. Similarly the UE CONTEXT SETUP REQUEST message includes UP Transport Layer Information IE in DRB to Be Setup Item IE with the information in the CN Tunnel Info that is received in INITIAL CONTEXT SETUP REQUEST message at step 7. With this treatment or this process, the user data in uplink direction is transferred from the gNB-DU 61 to the UPF 7201 directly.

Upon reception of the UE CONTEXT SETUP REQUEST message, the gNB-DU 61 sends, to the gNB-CU-CP 6201, the UE CONTEXT SETUP RESPONSE message including the DL UP TNL Information in DL UP TNL Information to Be Setup Item IE.

11. The gNB-CU-CP 6201 sends, to the AMF 70, INITIAL CONTEXT SETUP RESPONSE message including DL QoS Flow per TNL Information in PDU Session Resource Setup Response Item IE with the DL UP TNL Information that is received in UE CONTEXT SETUP RESPONSE message at step 10. With this treatment or this process, the user data in downlink direction is transferred from the UPF 7201 to the gNB-DU 61 directly.

12. The PDU session establishment procedure continues from step 15 section 4.3.2.2.1 in NPL 14.

### <First Variant of the Second Aspect: Service Request Procedure>

The Service request procedure for NG-(R)AN architecture without gNB-CU-UP can be realized with following changes to the second aspect.
In step 1, the RRC message includes the Service Request message instead of the PDU Session Establishment Request message.
In step 2, the UPLINK NAS TRANSPORT message includes the Service Request message instead of the PDU Session Establishment Request message.
In step 3, the message name is Nsmf_PDUSession_UpdateSMContext Request instead of Nsmf_PDUSession_CreateSMContext Request. For example, the AMF 70 may send Nsmf_PDUSession_UpdateSMContext Request message instead of the Nsmf_PDUSession_CreateSMContext Request message.
In step 4, the message name is Nsmf_PDUSession_UpdateSMContext Response instead of Nsmf_PDUSession_CreateSMContext Response. For example, SMF 7201 may send Nsmf_PDUSession_UpdateSMContext Response message instead of the Nsmf_PDUSession_CreateSMContext Response message.
In step 12, the procedure to be continued is from the step 15 of the UE Triggered Service Request procedure in section 4.2.3.2 in NPL 14.

### <Second Variant of the Second Aspect: Optimized Service Flow>

In one example, both step 8 and step 9 in FIG. 5 can be omitted.

This omission is possible as the PDU Session resource setup list and related information are reserved by the UPF itself at step 5 and informed them to the gNB-CU-CP 6201 via the AMF 70 at step 6 and step 7.

<Third Variant of the Second Aspect: Inter gNB-CU-CP Handover>

In case that the inter gNB-CU-CP handover is triggered after step 12, the source gNB-CU-CP includes, to the HANDOVER REQUEST message, an indication per PDU session indicating whether the no gNB-CU-UP feature is applied to the PDU session or not so that the target gNB-CU-CP may contentiously treat the PDU session with the no gNB-CU-UP feature depending on a status of the capability negotiation between the target gNB-CU-CP and the UPF in the GNB-CU-CP E1 SETUP procedure.

At least one of the second aspect and the variants of the second aspect propose solutions for providing an optimized User plane handling in 5GS.

For example, at least one of the second aspect and the variants of the second aspect propose solutions for improving the latency on user data handling in 5GS.

For example, according to at least one of the second aspect and the variants of the second aspect, gNB-CU-UP failure due to hardware failure, virtual resource failure and related facility failure can be reduced as the total number of involved hardware for the PDU session end to end can be lower.

For example, according to at least one of the second aspect and the variants of the second aspect, a service quality in transport layer in 5GS can be improved as it can diminish the N3 connection.

For example, at least one of the second aspect and the variants of the second aspect can solve a problem regarding a transmission delay whenever user data traverses the user plane entities.

For example, at least one of the second aspect and the variants of the second aspect can solve a problem that the current 5GS architecture may be too redundant to fulfill the low latency requirement for time critical application.

### <System Overview>

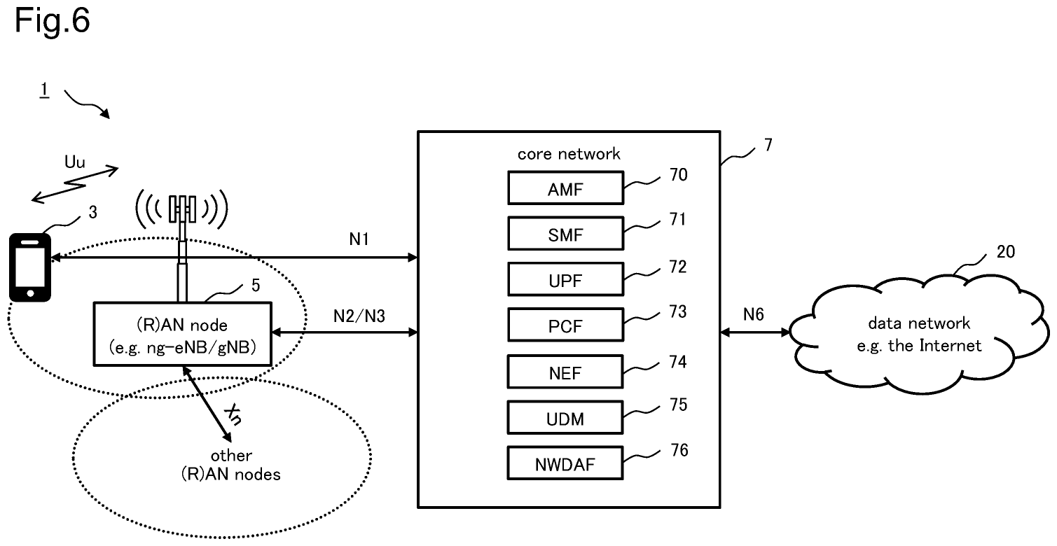

FIG. 6 schematically illustrates a telecommunication system 1 for a mobile (cellular or wireless) device (known as a user equipment (UE)) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into one or more control plane functions and one or more user plane functions. Further, multiple user plane functions can be allocated to support a communication. In some aspects, user traffic may be distributed to multiple user plane functions and user traffic over each user plane function is aggregated in both the UE 3 and the (R)AN node 5. This split architecture may be called ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical node can be considered as a network function. The network function may be provided to another node by adapting the Service Based Architecture (SBA).

A Network Function (NF) can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, and a Network Data Analytics Function (NWDAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN nodes 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane and User plane.

The User plane of the Uu interface is responsible to convey user traffic between the UE 3 and a serving (R)AN node 5. The User plane of the Uu interface may have a layered structure with SDAP, PDCP, RLC and MAC sublayer over the physical connection.

The Control plane of the Uu interface is responsible to establish, modify and release a connection between the UE 3 and a serving (R)AN node 5. The Control plane of the Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by some aspects in this disclosure, any of the following parameters may be included together in the RRC Setup Request message.
   establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by some aspects in this disclosure, any of the following parameters may be included together in the RRC Setup message.
   masterCellGroup and radioBearerConfig
RRC Setup Complete message: This message is sent from the UE 3 to the (R)AN node 5. In addition to the parameters that are disclosed by some aspects in this disclosure, any of the following parameters may be included together in the RRC Setup Complete message.
   guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible for providing a communication between the UE 3 and the AMF 70 to support NAS signaling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by some aspects in this disclosure, any of the following parameters may be included together in the Registration Request message.
   5GS registration type, ngKSI, 5GS mobile identity, Non-current native NAS key set identifier, 5GMM capability, UE security capability, Requested NSSAI, Last visited registered TAI, Si UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by some aspects in this disclosure, any of the following parameters may be included together in the Registration Accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by some aspects in this disclosure, the following parameter may be included together in the Registration Complete message.
   SOR transparent container.
Authentication Request message: This message is sent from the AMF 70 to the UE 3. In addition to the parameters that are disclosed by some aspects in this disclosure, any of the following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by some aspects in this disclosure, any of the following parameters may be populated together in the Authentication Response message.
   Authentication response message identity, Authentication response parameter and EAP message.
Authentication Result message: This message is sent from the AMF 70 to the UE 3. In addition to the parameters that are disclosed by some aspects in this disclosure, any of the following parameters may be populated together in the Authentication Result message.
   ngKSI, EAP message and ABBA.
Authentication Failure message: This message is sent from the UE 3 to the AMF 70. In addition to the parameters that are disclosed by some aspects in this disclosure, any of the following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by some aspects in this disclosure, the following parameter may be populated together in the Authentication Reject message.
   EAP message.
Service Request message: This message is sent from the UE 3 to the AMF 70. In addition to the parameters that are disclosed by some aspects in this disclosure, any of the following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by some aspects in this disclosure, any of the following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by some aspects in this disclosure, any of the following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by some aspects in this disclosure, any of the following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by some aspects in this disclosure, the following parameter may be populated together in the Configuration Update Complete message.
   Configuration update complete message identity.

### <User Equipment (UE)>

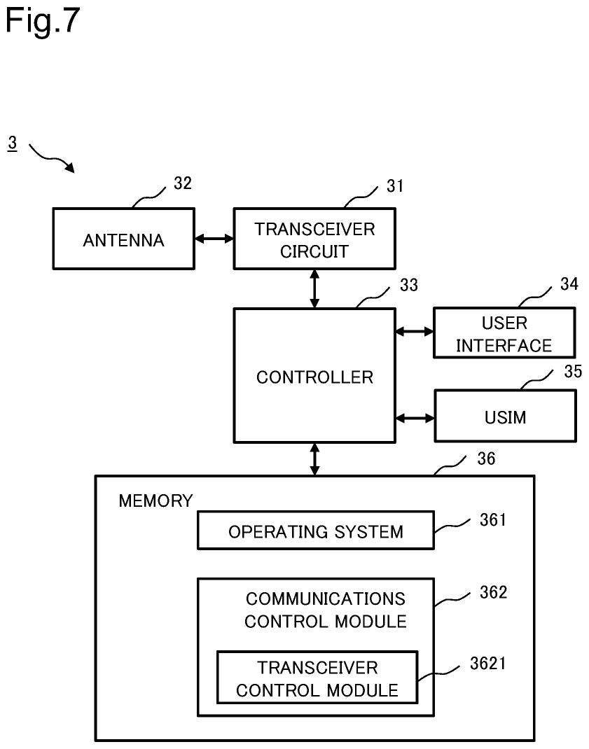

FIG. 7 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (e.g. a removable memory device (RMD)), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)an Node>

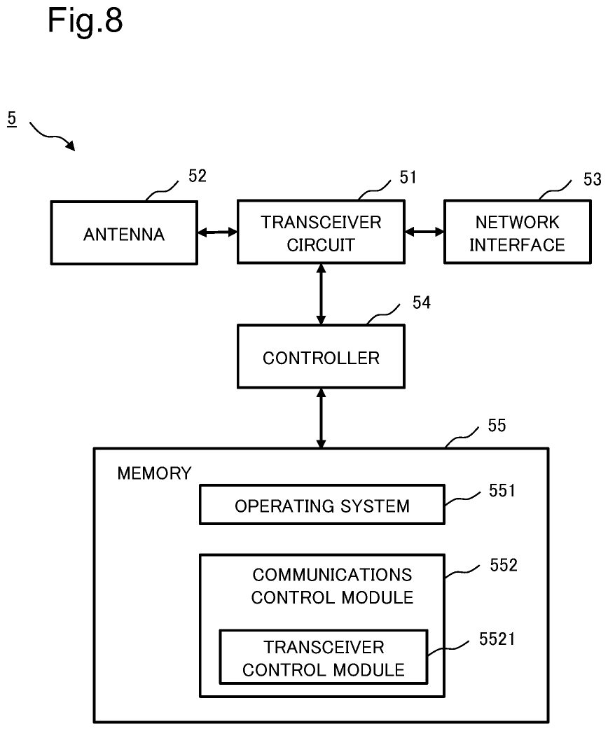

FIG. 8 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (e.g. an RMD), for example.

The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimation and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

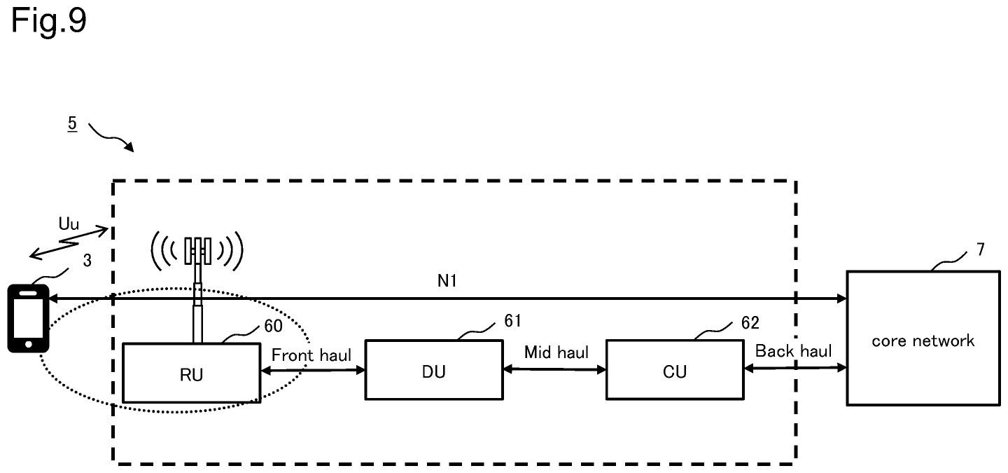

FIG. 9 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. The Centralized Unit may be called as Central Unit. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU-Control plane (CU-CP) and CU-User plane (CU-UP). The CU-CP has a control plane functionality in the (R)AN node 5. The CU-UP has a user plane functionality in the (R)AN node 5. Each CU-CP is connected to the CU-UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionality to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

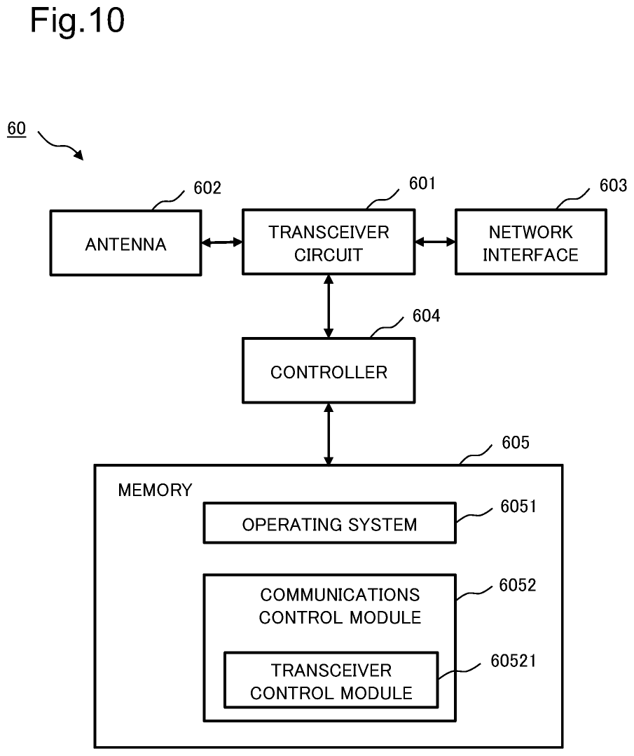

FIG. 10 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (e.g. a removable memory device (RMD)), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

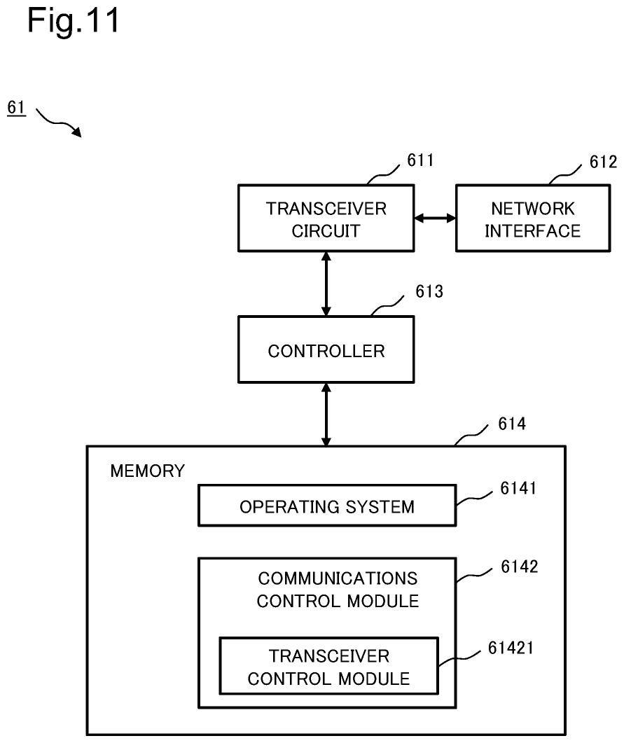

FIG. 11 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (e.g. a removable memory device (RMD)), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the DU 61 can be integrated/combined with the RU 60 or CU 62 as an integrated/combined unit. Any functionality in the description for DU 61 can be implemented in one of the integrated/combined unit above.

The gNB-DU may have same components to the DU 61.

### <Centralized Unit/Central Unit (CU)>

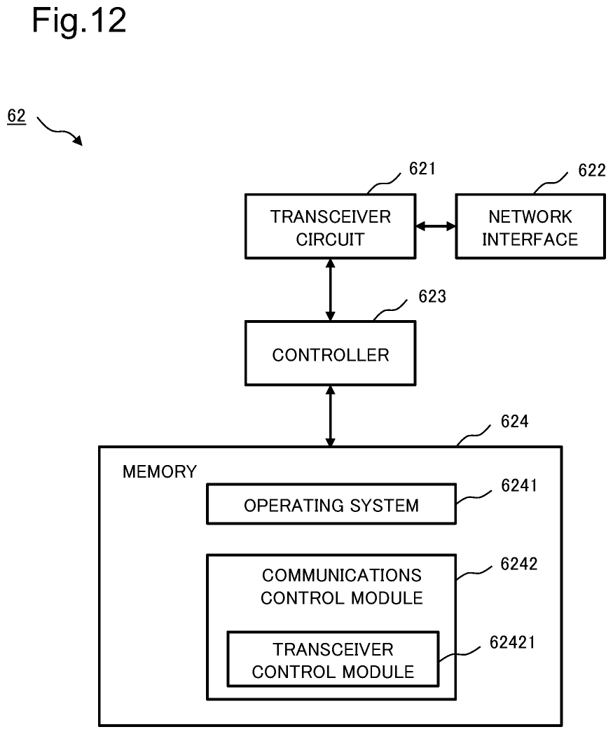

FIG. 12 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (e.g. a removable memory device (RMD)), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

The gNB-CU-CP may have same components to the CU 62.

The gNB-CU-UP may have same components to the CU 62.

### <AMF>

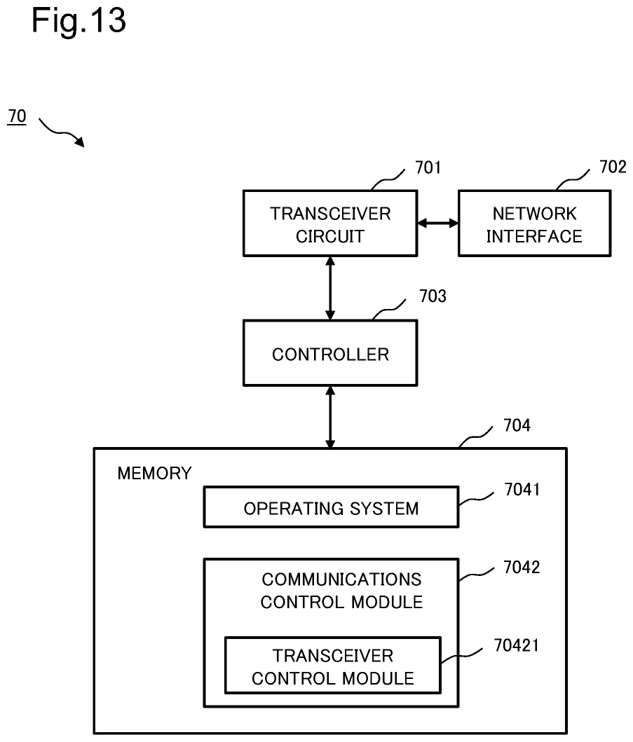

FIG. 13 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (e.g. a removable memory device (RMD)), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <SMF>

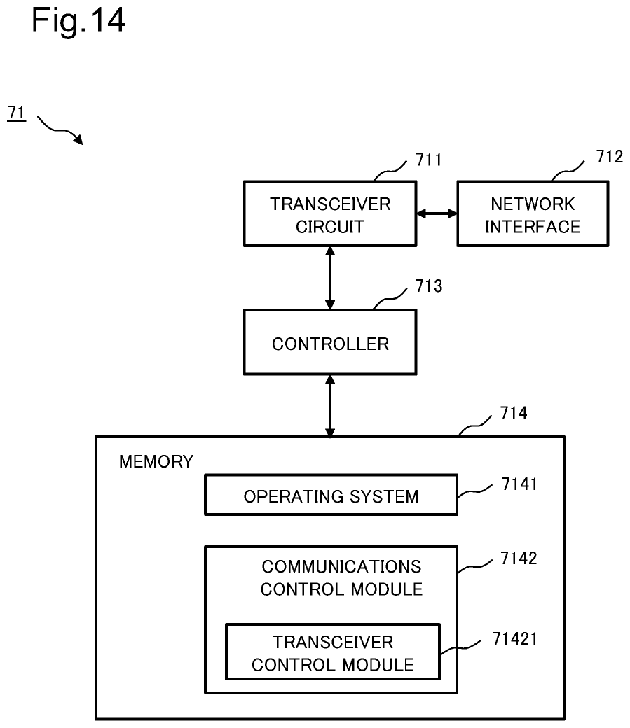

FIG. 14 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable memory device (RMD), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### <UPF>

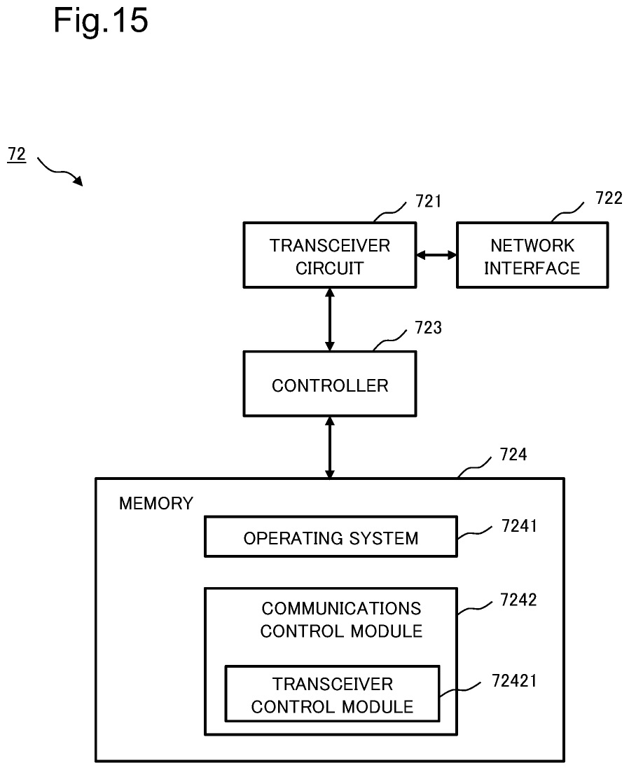

FIG. 15 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g. a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

The collocated gNB-CU-UP and UPF or the communication apparatus executing function of a collocated gNB-CU-UP and UPF or the communication apparatus executing function of the gNB-CU-UP and function of the UPF may have same components to the UPF 72.

### <PCF>

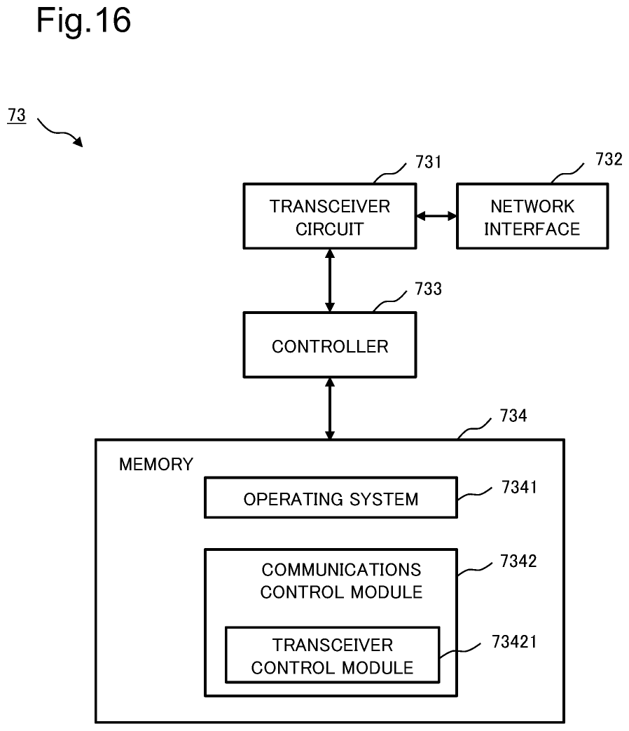

FIG. 16 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### <NEF>

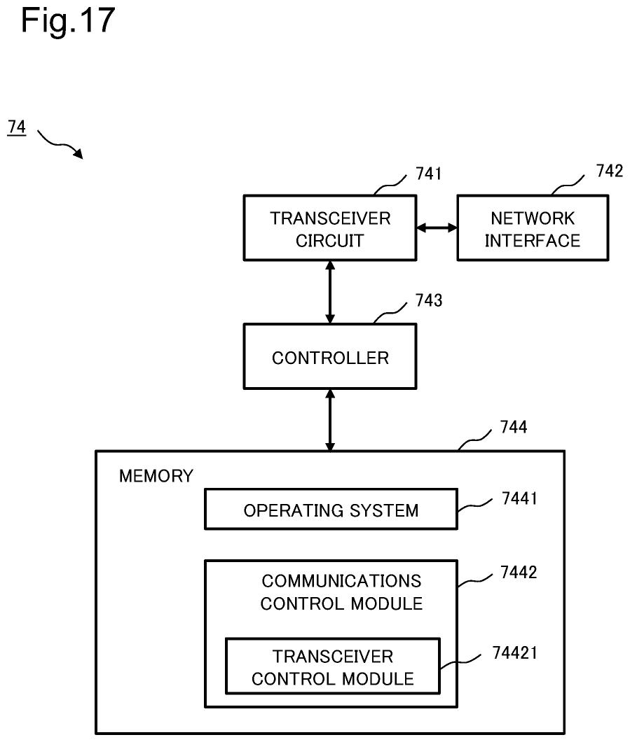

FIG. 17 is a block diagram illustrating the main components of the NEF 74. As shown, the apparatus includes a transceiver circuit 741 which is operable to transmit signals to and to receive signals from other nodes (including the UDM 75) via a network interface 742. A controller 743 controls the operation of the NEF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the NEF 74 and other nodes, such as the UDM 75 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network exposure function procedures (for the UE 3).

The NEF 74 may support the Non-Public Network (NPN), The NPN may be a Stand-alone Non-Public Network (SNPN) or a Public Network Integrated NPN (PNI-NPN).

### <UDM>

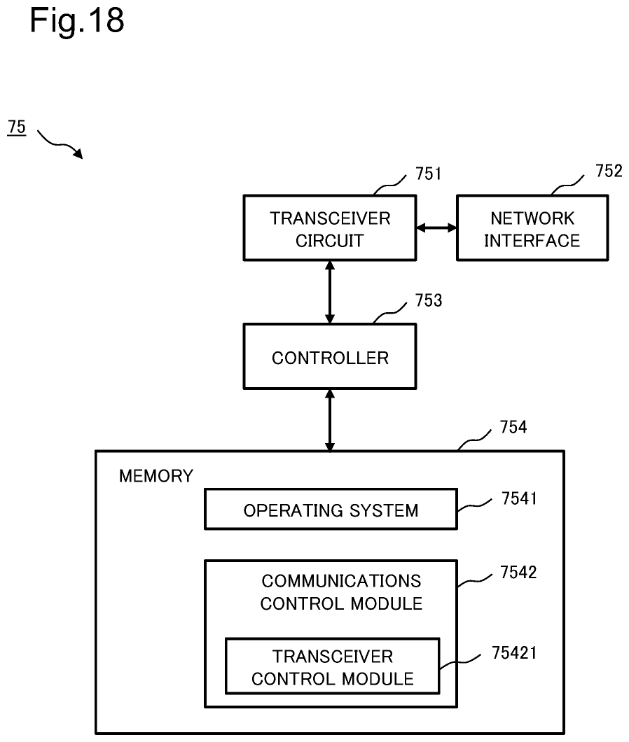

FIG. 18 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (e.g. a removable memory device (RMD)), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NWDAF>

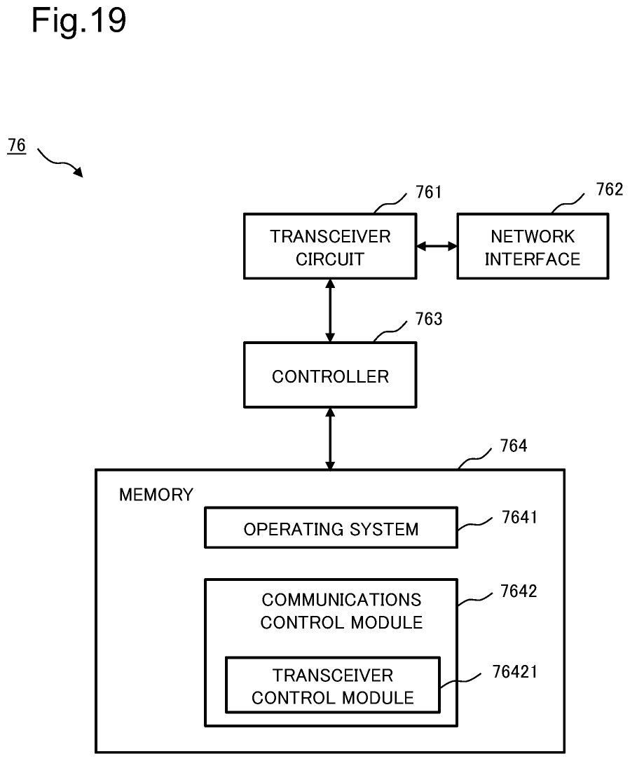

FIG. 19 is a block diagram illustrating the main components of the NWDAF 76. As shown, the apparatus includes a transceiver circuit 761 which is operable to transmit signals to and to receive signals from other nodes (including the AMF 70) via a network interface 762. A controller 763 controls the operation of the NWDAF 76 in accordance with the software stored in a memory 764. The Software may be pre-installed in the memory 764 and/or may be downloaded via the telecommunication network or from a removable data storage device (e.g. a removable memory device (RMD)), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NWDAF 76 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NWDAF 76 may support the Non-Public Network (NPN), The NPN may be a Stand-alone Non-Public Network (SNPN) or a Public Network Integrated NPN (PNI-NPN).

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

The whole or part of the example Aspects disclosed above can be described as, but not limited to, the following supplementary notes.

supplementary note 1. A method of a communication apparatus, the method comprising:
executing a function of a gNB-Centralized Unit-User Plane (gNB-CU-UP) apparatus and function of a User Plain Function (UPF) apparatus;
communicating with a gNB-Distributed Unit (gNB-DU) apparatus; and
communicating with a gNB-Centralized Unit-Control Plane (gNB-CU-CP) apparatus.

supplementary note 2. A method of a gNB-Centralized Unit-Control Plane (gNB-CU-CP) apparatus, the method comprising:
receiving a Protocol Data Unit (PDU) session establishment request message from a User Equipment (UE);
sending a UPLINK NAS TRANSPORT message to an Access and Mobility management Function (AMF) apparatus,
wherein the UPLINK NAS TRANSPORT message includes the PDU session establishment request message and information indicating that the gNB-CU-CP apparatus supports communication with a communication apparatus which executes a function of a gNB-Centralized Unit-User Plane (gNB-CU-UP) apparatus and function of a User Plain Function (UPF) apparatus;
receiving an INITIAL CONTEXT SETUP REQUEST message from the AMF apparatus,
wherein the INITIAL CONTEXT SETUP REQUEST message includes information related to the gNB-CU-UP;
selecting the gNB-CU-UP based on the information related to the gNB-CU-UP; and
performing PDU session establishment procedure for the UE.

supplementary note 3. A method of an Access and Mobility management Function (AMF) apparatus, the method comprising:
receiving an UPLINK NAS TRANSPORT message from a gNB-Centralized Unit-Control Plane (gNB-CU-CP) apparatus,
wherein the UPLINK NAS TRANSPORT message includes a Protocol Data Unit (PDU) session establishment request message and information indicating that the gNB-CU-CP apparatus supports communication with a communication apparatus which executes function of a gNB-Centralized Unit-User Plane (gNB-CU-UP) apparatus and function of a User Plain Function (UPF) apparatus;
sending a Nsmf_PDUSession_CreateSMContext Request message to a Session Management Function (SMF) apparatus,
wherein the Nsmf_PDUSession_CreateSMContext Request message includes the information;
receiving a Nsmf_PDUSession_CreateSMContext response message from the SMF apparatus,
wherein the Nsmf_PDUSession_CreateSMContext response message includes information related to the UPF apparatus;
receiving a Namf_Communication_N1N2MessageTransfer message from the SMF apparatus,
wherein the Namf_Communication_N1N2MessageTransfer message includes information related to the gNB-CU-UP apparatus;
sending an INITIAL CONTEXT SETUP REQUEST message to the gNB-CU-CP apparatus,
wherein the INITIAL CONTEXT SETUP REQUEST message includes the information related to the gNB-CU-UP apparatus; and
performing PDU session establishment procedure.

supplementary note 4. A method of a Session Management Function (SMF) apparatus, the method comprising:
receiving a Nsmf_PDUSession_CreateSMContext Request message from an Access and Mobility management Function (AMF) apparatus,
wherein the Nsmf_PDUSession_CreateSMContext Request message includes information indicating that a gNB-Centralized Unit-Control Plane (gNB-CU-CP) apparatus supports communication with a communication apparatus which executes function of a gNB-Centralized Unit-User Plane (gNB-CU-UP) apparatus and function of a User Plain Function (UPF) apparatus;
sending a Nsmf_PDUSession_CreateSMContext response message to the AMF apparatus,
wherein the Nsmf_PDUSession_CreateSMContext response message includes information related to the UPF apparatus;
selecting the UPF apparatus in a case where the Nsmf_PDUSession_CreateSMContext Request message includes the information;
contacting to the communication apparatus for reserving a resource for handling of user data;
sending a Namf_Communication_N1N2MessageTransfer message to the AMF apparatus,
wherein the Namf_Communication_N1N2MessageTransfer message includes information related to the gNB-CU-UP apparatus; and
performing PDU session establishment procedure.

supplementary note 5. A method of a gNB-Distributed Unit (gNB-DU) apparatus, the method comprising:
communicating with a gNB-Centralized Unit-Control Plane (gNB-CU-CP) apparatus; and
communicating with a User Plane Function (UPF) apparatus without a gNB-Centralized Unit-User Plane (gNB-CU-UP) apparatus.

supplementary note 6. A method of a gNB-Centralized Unit-Control Plane (gNB-CU-CP) apparatus, the method comprising:
communicating with a gNB-Distributed Unit (gNB-DU) apparatus; and
communicating with a User Plane Function (UPF) apparatus without a gNB-Centralized Unit-User Plane (gNB-CU-UP) apparatus.

supplementary note 7. The method according to supplementary note 6, further comprising:
receiving a GNB-CU-CP E1 SETUP REQUEST message from the UPF apparatus,
wherein the GNB-CU-CP E1 SETUP REQUEST message includes first information indicating that the UPF apparatus supports that the gNB-DU apparatus is connected to the UPF apparatus without the gNB-CU-UP apparatus;
sending a GNB-CU-CP E1 SETUP RESPONSE message to the UPF apparatus,
wherein the GNB-CU-CP E1 SETUP RESPONSE message includes second information indicating that the gNB-CU-CP apparatus supports that the gNB-DU apparatus is connected to the UPF apparatus without the gNB-CU-UP apparatus;
receiving a Protocol Data Unit (PDU) session establishment request message from a User Equipment (UE);
sending an UPLINK NAS TRANSPORT message to an Access and Mobility management Function (AMF) apparatus,
wherein the UPLINK NAS TRANSPORT message includes the second information;
receiving an INITIAL CONTEXT SETUP REQUEST message from the AMF apparatus,
wherein the INITIAL CONTEXT SETUP REQUEST message includes gNB-CU-UP UE E1AP ID and third information indicating a pair of an Internet Protocol (IP) address and a Tunnel Endpoint Identifier (TEID) for uplink data handling;
sending a UE CONTEXT SETUP REQUEST message to the gNB-DU apparatus,
wherein the UE CONTEXT SETUP REQUEST message the third information and UL Configuration Information Element (IE);
receiving a UE CONTEXT SETUP RESPONSE message from the gNB-DU apparatus;
sending an INITIAL CONTEXT SETUP RESPONSE message to the AMF apparatus; and
performing PDU session establishment procedure.

supplementary note 8. A method of an Access and Mobility management Function (AMF) apparatus, the method comprising:
receiving an UPLINK NAS TRANSPORT message from a gNB-Centralized Unit-Control Plane (gNB-CU-CP) apparatus,
wherein the UPLINK NAS TRANSPORT message includes first information indicating that the gNB-CU-CP apparatus supports that a gNB-Distributed Unit (gNB-DU) apparatus is connected to a User Plane Function (UPF) apparatus without a gNB-Centralized Unit-User Plane (gNB-CU-UP) apparatus;
sending a Nsmf_PDUSession_CreateSMContext Request message to a Session Management Function (SMF) apparatus,
wherein the Nsmf_PDUSession_CreateSMContext Request message includes the first information;
receiving a Nsmf_PDUSession_CreateSMContext response message from the SMF apparatus,
wherein the Nsmf_PDUSession_CreateSMContext response message includes second information indicating that the UPF apparatus supports that the gNB-DU apparatus is connected to the UPF apparatus without the gNB-CU-UP apparatus;
receiving a Namf_Communication_N1N2MessageTransfer message from the SMF apparatus,
wherein the Namf_Communication_N1N2MessageTransfer message includes gNB-CU-UP UE E1AP ID and third information indicating a pair of an Internet Protocol (IP) address and a Tunnel Endpoint Identifier (TEID) for uplink data handling;
sending an INITIAL CONTEXT SETUP REQUEST message to the gNB-CU-CP apparatus,
wherein the INITIAL CONTEXT SETUP REQUEST message includes the gNB-CU-UP UE E1AP ID and the third information;
receiving an INITIAL CONTEXT SETUP RESPONSE message from the gNB-CU-CP apparatus; and
performing PDU session establishment procedure.

supplementary note 9. A method of a Session Management Function (SMF) apparatus, the method comprising:
receiving a Nsmf_PDUSession_CreateSMContext Request message from an Access and Mobility management Function (AMF) apparatus,
wherein the Nsmf_PDUSession_CreateSMContext Request message includes first information indicating that a gNB-Centralized Unit-Control Plane (gNB-CU-CP) apparatus supports that a gNB-Distributed Unit (gNB-DU) apparatus is connected to a User Plane Function (UPF) apparatus without a gNB-Centralized Unit-User Plane (gNB-CU-UP) apparatus;
sending a Nsmf_PDUSession_CreateSMContext response message to the AMF apparatus,
wherein the Nsmf_PDUSession_CreateSMContext response message includes second information indicating that the UPF apparatus supports that the gNB-DU apparatus is connected to the UPF apparatus without the gNB-CU-UP apparatus;
sending a N4 Session Establishment Request message to the UPF apparatus,
wherein the N4 Session Establishment Request message includes the first information;
receiving a N4 Session Establishment Response message from the UPF apparatus,
wherein the N4 Session Establishment Response message includes gNB-CU-UP UE E1AP ID and third information indicating a pair of an Internet Protocol (IP) address and a Tunnel Endpoint Identifier (TEID) for uplink data handling;
sending a Namf_Communication_N1N2MessageTransfer message to the AMF apparatus,
wherein the Namf_Communication_N1N2MessageTransfer message includes the gNB-CU-UP UE E1AP ID and the third information; and
performing PDU session establishment procedure.

supplementary note 10. A method of a User Plane Function (UPF) apparatus, the method comprising:
communicating with a gNB-Distributed Unit (gNB-DU) apparatus without a gNB-Centralized Unit-User Plane (gNB-CU-UP) apparatus; and
communicating with a gNB-Centralized Unit-Control Plane (gNB-CU-CP) apparatus without the gNB-CU-UP apparatus.

supplementary note 11. The method according to supplementary note 10, further comprising:
sending a GNB-CU-CP E1 SETUP REQUEST message to the gNB-CU-CP apparatus,
wherein the GNB-CU-CP E1 SETUP REQUEST message includes first information indicating that the UPF apparatus supports that the gNB-DU apparatus is connected to the UPF apparatus without the gNB-CU-UP apparatus;
receiving a GNB-CU-CP E1 SETUP RESPONSE message from the gNB-CU-CP apparatus,
wherein the GNB-CU-CP E1 SETUP RESPONSE message includes second information indicating that the gNB-CU-CP apparatus supports that the gNB-DU apparatus is connected to the UPF apparatus without the gNB-CU-UP apparatus;
receiving a N4 Session Establishment Request message from a Session Management Function (SMF) apparatus,
wherein the N4 Session Establishment Request message includes the second information;
sending a N4 Session Establishment Response message to the SMF apparatus,
wherein the N4 Session Establishment Response message includes gNB-CU-UP UE E1AP ID and third information indicating a pair of an Internet Protocol (IP) address and a Tunnel Endpoint Identifier (TEID) for uplink data handling; and
performing PDU session establishment procedure.

supplementary note 12. A communication apparatus comprising:
means for executing a function of a gNB-Centralized Unit-User Plane (gNB-CU-UP) apparatus and function of a User Plain Function (UPF) apparatus;
means for communicating with a gNB-Distributed Unit (gNB-DU) apparatus; and
means for communicating with a gNB-Centralized Unit-Control Plane (gNB-CU-CP) apparatus.

supplementary note 13. A gNB-Centralized Unit-Control Plane (gNB-CU-CP) apparatus comprising:
means for receiving a Protocol Data Unit (PDU) session establishment request message from a User Equipment (UE);
means for sending an UPLINK NAS TRANSPORT message to an Access and Mobility management Function (AMF) apparatus,
wherein the UPLINK NAS TRANSPORT message includes the PDU session establishment request message and information indicating that the gNB-CU-CP apparatus supports communication with a communication apparatus which executes a function of a gNB-Centralized Unit-User Plane (gNB-CU-UP) apparatus and function of a User Plain Function (UPF) apparatus;
means for receiving an INITIAL CONTEXT SETUP REQUEST message from the AMF apparatus,
wherein the INITIAL CONTEXT SETUP REQUEST message includes information related to the gNB-CU-UP;
means for selecting the gNB-CU-UP based on the information related to the gNB-CU-UP; and
means for performing PDU session establishment procedure for the UE.

supplementary note 14. An Access and Mobility management Function (AMF) apparatus comprising:
means for receiving an UPLINK NAS TRANSPORT message from a gNB-Centralized Unit-Control Plane (gNB-CU-CP) apparatus,
wherein the UPLINK NAS TRANSPORT message includes a Protocol Data Unit (PDU) session establishment request message and information indicating that the gNB-CU-CP apparatus supports communication with a communication apparatus which executes function of a gNB-Centralized Unit-User Plane (gNB-CU-UP) apparatus and function of a User Plain Function (UPF) apparatus;
means for sending a Nsmf_PDUSession_CreateSMContext Request message to a Session Management Function (SMF) apparatus,
wherein the Nsmf_PDUSession_CreateSMContext Request message includes the information;
means for receiving a Nsmf_PDUSession_CreateSMContext response message from the SMF apparatus,
wherein the Nsmf_PDUSession_CreateSMContext response message includes information related to the UPF apparatus;
means for receiving a Namf_Communication_N1N2MessageTransfer message from the SMF apparatus,
wherein the Namf_Communication_N1N2MessageTransfer message includes information related to the gNB-CU-UP apparatus;
means for sending an INITIAL CONTEXT SETUP REQUEST message to the gNB-CU-CP apparatus,
wherein the INITIAL CONTEXT SETUP REQUEST message includes the information related to the gNB-CU-UP apparatus; and
means for performing PDU session establishment procedure.

supplementary note 15. A Session Management Function (SMF) apparatus comprising:
means for receiving a Nsmf_PDUSession_CreateSMContext Request message from an Access and Mobility management Function (AMF) apparatus,
wherein the Nsmf_PDUSession_CreateSMContext Request message includes information indicating that a gNB-Centralized Unit-Control Plane (gNB-CU-CP) apparatus supports communication with a communication apparatus which executes function of a gNB-Centralized Unit-User Plane (gNB-CU-UP) apparatus and function of a User Plain Function (UPF) apparatus;
means for sending a Nsmf_PDUSession_CreateSMContext response message to the AMF apparatus,
wherein the Nsmf_PDUSession_CreateSMContext response message includes information related to the UPF apparatus;
means for selecting the UPF apparatus in a case where the Nsmf_PDUSession_CreateSMContext Request message includes the information;
means for contacting to the communication apparatus for reserving a resource for handling of user data;
means for sending a Namf_Communication_N1N2MessageTransfer message to the AMF apparatus,
wherein the Namf_Communication_N1N2MessageTransfer message includes information related to the gNB-CU-UP apparatus; and
means for performing PDU session establishment procedure.

supplementary note 16. A gNB-Distributed Unit (gNB-DU) apparatus comprising:
means for communicating with a gNB-Centralized Unit-Control Plane (gNB-CU-CP) apparatus; and
means for communicating with a User Plane Function (UPF) apparatus without a gNB-Centralized Unit-User Plane (gNB-CU-UP) apparatus.

supplementary note 17. A gNB-Centralized Unit-Control Plane (gNB-CU-CP) apparatus comprising:
means for communicating with a gNB-Distributed Unit (gNB-DU) apparatus; and
means for communicating with a User Plane Function (UPF) apparatus without a gNB-Centralized Unit-User Plane (gNB-CU-UP) apparatus.

supplementary note 18. The gNB-CU-CP apparatus according to supplementary note 17, further comprising:
means for receiving a GNB-CU-CP E1 SETUP REQUEST message from the UPF apparatus,
wherein the GNB-CU-CP E1 SETUP REQUEST message includes first information indicating that the UPF apparatus supports that the gNB-DU apparatus is connected to the UPF apparatus without the gNB-CU-UP apparatus;
means for sending a GNB-CU-CP E1 SETUP RESPONSE message to the UPF apparatus,
wherein the GNB-CU-CP E1 SETUP RESPONSE message includes second information indicating that the gNB-CU-CP apparatus supports that the gNB-DU apparatus is connected to the UPF apparatus without the gNB-CU-UP apparatus;
means for receiving a Protocol Data Unit (PDU) session establishment request message from a User Equipment (UE);
means for sending a UPLINK NAS TRANSPORT message to an Access and Mobility management Function (AMF) apparatus,
wherein the UPLINK NAS TRANSPORT message includes the second information;
means for receiving an INITIAL CONTEXT SETUP REQUEST message from the AMF apparatus,
wherein the INITIAL CONTEXT SETUP REQUEST message includes gNB-CU-UP UE E1AP ID and third information indicating a pair of an Internet Protocol (IP) address and a Tunnel Endpoint Identifier (TEID) for uplink data handling;
means for sending a UE CONTEXT SETUP REQUEST message to the gNB-DU apparatus,
wherein the UE CONTEXT SETUP REQUEST message the third information and UL Configuration Information Element (IE);
means for receiving a UE CONTEXT SETUP RESPONSE message from the gNB-DU apparatus;
means for sending an INITIAL CONTEXT SETUP RESPONSE message to the AMF apparatus; and
means for performing PDU session establishment procedure.

supplementary note 19. An Access and Mobility management Function (AMF) apparatus comprising:
means for receiving an UPLINK NAS TRANSPORT message from a gNB-Centralized Unit-Control Plane (gNB-CU-CP) apparatus,
wherein the UPLINK NAS TRANSPORT message includes first information indicating that the gNB-CU-CP apparatus supports that a gNB-Distributed Unit (gNB-DU) apparatus is connected to a User Plane Function (UPF) apparatus without a gNB-Centralized Unit-User Plane (gNB-CU-UP) apparatus;
means for sending a Nsmf_PDUSession_CreateSMContext Request message to a Session Management Function (SMF) apparatus,
wherein the Nsmf_PDUSession_CreateSMContext Request message includes the first information;
means for receiving a Nsmf_PDUSession_CreateSMContext response message from the SMF apparatus,
wherein the Nsmf_PDUSession_CreateSMContext response message includes second information indicating that the UPF apparatus supports that the gNB-DU apparatus is connected to the UPF apparatus without the gNB-CU-UP apparatus;
means for receiving a Namf_Communication_N1N2MessageTransfer message from the SMF apparatus,
wherein the Namf_Communication_N1N2MessageTransfer message includes gNB-CU-UP UE E1AP ID and third information indicating a pair of an Internet Protocol (IP) address and a Tunnel Endpoint Identifier (TEID) for uplink data handling;
means for sending an INITIAL CONTEXT SETUP REQUEST message to the gNB-CU-CP apparatus,
wherein the INITIAL CONTEXT SETUP REQUEST message includes the gNB-CU-UP UE E1AP ID and the third information;
means for receiving an INITIAL CONTEXT SETUP RESPONSE message from the gNB-CU-CP apparatus; and
means for performing PDU session establishment procedure.

supplementary note 20. A Session Management Function (SMF) apparatus comprising:
means for receiving a Nsmf_PDUSession_CreateSMContext Request message from an Access and Mobility management Function (AMF) apparatus,
wherein the Nsmf_PDUSession_CreateSMContext Request message includes first information indicating that a gNB-Centralized Unit-Control Plane (gNB-CU-CP) apparatus supports that a gNB-Distributed Unit (gNB-DU) apparatus is connected to a User Plane Function (UPF) apparatus without a gNB-Centralized Unit-User Plane (gNB-CU-UP) apparatus;
means for sending a Nsmf_PDUSession_CreateSMContext response message to the AMF apparatus,
wherein the Nsmf_PDUSession_CreateSMContext response message includes second information indicating that the UPF apparatus supports that the gNB-DU apparatus is connected to the UPF apparatus without the gNB-CU-UP apparatus;
means for sending a N4 Session Establishment Request message to the UPF apparatus,
wherein the N4 Session Establishment Request message includes the first information;
means for receiving a N4 Session Establishment Response message from the UPF apparatus,
wherein the N4 Session Establishment Response message includes gNB-CU-UP UE E1AP ID and third information indicating a pair of an Internet Protocol (IP) address and a Tunnel Endpoint Identifier (TEID) for uplink data handling;
means for sending a Namf_Communication_N1N2MessageTransfer message to the AMF apparatus,
wherein the Namf_Communication_N1N2MessageTransfer message includes the gNB-CU-UP UE E1AP ID and the third information; and
means for performing PDU session establishment procedure.

supplementary note 21. A User Plane Function (UPF) apparatus comprising:
means for communicating with a gNB-Distributed Unit (gNB-DU) apparatus without a gNB-Centralized Unit-User Plane (gNB-CU-UP) apparatus; and
means for communicating with a gNB-Centralized Unit-Control Plane (gNB-CU-CP) apparatus without the gNB-CU-UP apparatus.

supplementary note 22. The UPF apparatus according to supplementary note 21, further comprising:
means for sending a GNB-CU-CP E1 SETUP REQUEST message to the gNB-CU-CP apparatus,
wherein the GNB-CU-CP E1 SETUP REQUEST message includes first information indicating that the UPF apparatus supports that the gNB-DU apparatus is connected to the UPF apparatus without the gNB-CU-UP apparatus;
means for receiving a GNB-CU-CP E1 SETUP RESPONSE message from the gNB-CU-CP apparatus,
wherein the GNB-CU-CP E1 SETUP RESPONSE message includes second information indicating that the gNB-CU-CP apparatus supports that the gNB-DU apparatus is connected to the UPF apparatus without the gNB-CU-UP apparatus;
means for receiving a N4 Session Establishment Request message from a Session Management Function (SMF) apparatus,
wherein the N4 Session Establishment Request message includes the second information;
means for sending a N4 Session Establishment Response message to the SMF apparatus,
wherein the N4 Session Establishment Response message includes gNB-CU-UP UE E1AP ID and third information indicating a pair of an Internet Protocol (IP) address and a Tunnel Endpoint Identifier (TEID) for uplink data handling; and
means for performing PDU session establishment procedure.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111039053, filed on Aug. 28, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
711 transceiver circuit
712 network interface
713 controller
714 memory
721 transceiver circuit
722 network interface
723 controller
724 memory
731 transceiver circuit
732 network interface
733 controller
734 memory
741 transceiver circuit
742 network interface
743 controller
744 memory
751 transceiver circuit
752 network interface
753 controller
754 memory
761 transceiver circuit
762 network interface
763 controller
764 memory
3621 transceiver control module
5521 transceiver control module
6051 operating system
6052 communications control module
6141 operating system
6142 communications control module
6241 operating system
6242 communications control module
7041 operating system
7042 communications control module
7141 operating system
7142 communications control module
7241 operating system
7242 communications control module
7341 operating system
7342 communications control module
7441 operating system
7442 communications control module
7541 operating system
7542 communications control module
7641 operating system
7642 communications control module
60521 transceiver control module
61421 transceiver control module
62421 transceiver control module
70421 transceiver control module
71421 transceiver control module
72421 transceiver control module
73421 transceiver control module
74421 transceiver control module
75421 transceiver control module
76421 transceiver control module

What is claimed is:

1. (canceled)

2. A method of a gNB Centralized Unit Control Plane (gNB-CU-CP) apparatus, the method comprising:
receiving a Protocol Data Unit (PDU) session establishment request message from a User Equipment (UE);
sending an UPLINK NAS TRANSPORT message to an Access and Mobility management Function (AMF) apparatus,
wherein the UPLINK NAS TRANSPORT message includes the PDU session establishment request message and information indicating that the gNB-CU-CP apparatus supports communication with a communication apparatus which executes a function of a gNB Centralized Unit User Plane (gNB-CU-UP) apparatus and a function of a User Plane Function (UPF) apparatus;
receiving an INITIAL CONTEXT SETUP REQUEST message from the AMF apparatus,
wherein the INITIAL CONTEXT SETUP REQUEST message includes information related to the gNB-CU-UP apparatus;
selecting the gNB-CU-UP apparatus based on the information related to the gNB-CU-UP apparatus; and
performing PDU session establishment procedure for the UE.

3. A method of an Access and Mobility management Function (AMF) apparatus, the method comprising:
receiving an UPLINK NAS TRANSPORT message from a gNB Centralized Unit Control Plane (gNB-CU-CP) apparatus,
wherein the UPLINK NAS TRANSPORT message includes a Protocol Data Unit (PDU) session establishment request message and information indicating that the gNB-CU-CP apparatus supports communication with a communication apparatus which executes a function of a gNB Centralized Unit User Plane (gNB-CU-UP) apparatus and a function of a User Plane Function (UPF) apparatus;
sending a Nsmf_PDUSession_CreateSMContext Request message to a Session Management Function (SMF) apparatus,
wherein the Nsmf_PDUSession_CreateSMContext Request message includes the information;
receiving a Nsmf_PDUSession_CreateSMContext response message from the SMF apparatus,
wherein the Nsmf_PDUSession_CreateSMContext response message includes information related to the UPF apparatus;
receiving a Namf_Communication_N1N2MessageTransfer message from the SMF apparatus,
wherein the Namf_Communication_N1N2MessageTransfer message includes information related to the gNB-CU-UP apparatus;
sending an INITIAL CONTEXT SETUP REQUEST message to the gNB-CU-CP apparatus,
wherein the INITIAL CONTEXT SETUP REQUEST message includes the information related to the gNB-CU-UP apparatus; and
performing PDU session establishment procedure.

4-12. (canceled)

13. A gNB Centralized Unit Control Plane (gNB-CU-CP) apparatus comprising one or more memories storing instructions and one or more processors configured to execute the instructions to:
receive a Protocol Data Unit (PDU) session establishment request message from a User Equipment (UE);
send an UPLINK NAS TRANSPORT message to an Access and Mobility management Function (AMF) apparatus,
wherein the UPLINK NAS TRANSPORT message includes the PDU session establishment request message and information indicating that the gNB-CU-CP apparatus supports communication with a communication apparatus which executes a function of a gNB Centralized Unit User Plane (gNB-CU-UP) apparatus and a function of a User Plane Function (UPF) apparatus;
receive an INITIAL CONTEXT SETUP REQUEST message from the AMF apparatus,
wherein the INITIAL CONTEXT SETUP REQUEST message includes information related to the gNB-CU-UP apparatus;
select the gNB-CU-UP apparatus based on the information related to the gNB-CU-UP apparatus; and
perform PDU session establishment procedure for the UE.

14-22. (canceled)
